(19) United States
(12) Patent Application Publication
(10) Pub. No.: US 2025/0253706 A1
(43) Pub. Date: Aug. 7, 2025

(54) ENERGY HARVESTER AND CHARGING APPARATUS

(71) Applicant: SONY SEMICONDUCTOR SOLUTIONS CORPORATION, Kanagawa (JP)

(72) Inventor: Yoshitaka YOSHINO, Kanagawa (JP)

(73) Assignee: SONY SEMICONDUCTOR SOLUTIONS CORPORATION, Kanagawa (JP)

(21) Appl. No.: 18/719,458

(22) PCT Filed: Dec. 21, 2022
(86) PCT No.: PCT/JP2022/047109

§ 371 Date: Jun. 13, 2024

(30) Foreign Application Priority Data
Dec. 22, 2021 (JP) 2021-207877

(51) Int. Cl. H02J 50/00; H01M 10/44; H01M 10/46; H02J 50/12; H02J 50/27; H02J 50/40

(52) U.S. Cl. CPC H02J 50/001; H01M 10/44; H01M 10/46; H02J 50/005; H02J 50/12; H02J 50/27; H02J 50/402

(57) ABSTRACT

An energy harvester according to an embodiment of the present technology includes a coil section, a maintaining portion, and a rectifier. The coil section includes a core that is made of a magnetic material, and a wire rod that is wound around the core. The maintaining portion maintains the coil section on a surface of a target that includes a metallic body or a human body, such that an axis of the coil section intersects the surface of the target. The rectifier rectifies output from the coil section.

### TECHNICAL FIELD

The present technology relates to an energy harvester and a charging apparatus that enable energy harvesting.

### BACKGROUND ART

Technologies that receive magnetic-field energy are conventionally known. For example, Patent Literature 1 discloses a contactless power transfer system in which two coils are electromagnetically coupled to each other to transfer power using magnetic-field energy. This system is provided with a resonant circuit that includes a power transmission coil and a resonant circuit that includes a power reception coil, where power is transferred between resonating devices. This makes it possible to efficiently receive energy of a magnetic field generated in the power transmission coil (for example, paragraphs [0019], [0042], and [0042] of the specification, and FIGS. 2 and 12 in Patent Literature 1).

### CITATION LIST

### Patent Literature

Patent Literature 1: Japanese Patent Application Laid-open No. 2016-66812

### DISCLOSURE OF INVENTION

### Technical Problem

The system described above is a system that receives energy of a magnetic field generated in the power transmission coil. However, the magnetic-field energy may be generated by an object that is not a coil. For example, when current flows into an object due to, for example, noise caused by an electric circuit or radio waves propagating through the air, a magnetic field depending on the current is generated around the object.

In recent years, energy harvesting that enables energy to be captured from a surrounding environment has attracted attention, and there is a need for a technology used to efficiently capture such energy of a magnetic field generated in a surrounding environment.

In view of the circumstances described above, it is an object of the present technology to provide an energy harvester and a charging apparatus that make it possible to efficiently capture energy of a magnetic field generated in a surrounding environment.

### Solution to Problem

In order to achieve the object described above, an energy harvester according to an embodiment of the present technology includes a coil section, a maintaining portion, and a rectifier.

The coil section includes a core that is made of a magnetic material, and a wire rod that is wound around the core.

The maintaining portion maintains the coil section on a surface of a target that includes a metallic body or a human body, such that an axis of the coil section intersects the surface of the target.

The rectifier rectifies output from the coil section.

In the energy harvester, the coil section is maintained on the surface of the target including a metallic body or a human body, such that the axis of the coil section intersects the surface of the target. Further, output from the coil section is rectified to be used as power. The core of the coil section is made of a magnetic material. Thus, magnetic flux generated around the target can be collected. This makes it possible to efficiently capture energy of a magnetic field that is generated in the surrounding environment.

The magnetic material of the core may be soft ferrite.

The core may include an axial portion around which the wire rod is wound, and a pair of flange portions respectively provided at two ends of the axial portion. In this case, the maintaining portion may maintain the coil section such that one of the pair of flange portions faces the target.

The core may include an axial portion around which the wire rod is wound, a flange portion that is provided at one of two ends of the axial portion, and a sidewall that is connected to the flange portion and spaced from the axial portion to surround at least a portion of the axial portion. In this case, the maintaining portion may maintain the coil section such that another of the two ends of the axial portion faces the target.

The maintaining portion may be a housing that accommodates therein the coil section and is attached to the surface of the target.

The housing may include an attachment surface that faces the surface of the target, and may maintain the coil section such that the axis of the coil section and the attachment surface are orthogonal to each other.

The core may include a first end surface that faces the target, and a second end surface that is situated opposite to the first end surface. In this case, the housing may maintain the coil section such that the first end surface of the core and the attachment surface coincide in a direction in which the axis of the coil section extends.

The energy harvester may further include a nonmagnetic body that is arranged at a specified distance from the coil section; and a circuit section that is arranged across the nonmagnetic body from the coil section, the circuit section including the rectifier.

The nonmagnetic body may be a plate member that has a thickness of greater than or equal to 0.3 mm.

The circuit section may include a circuit board in the form of a flat plate, the circuit board being arranged along the nonmagnetic body. In this case, the nonmagnetic body may be formed to cover a surface of the circuit board that faces the coil section.

The nonmagnetic body may be arranged parallel to the axis of the coil section, or may be arranged to be orthogonal to the axis of the coil section.

The energy harvester may further include a dipole-structure antenna section that includes a first antenna conductor that is electrically coupled to the target; and a second antenna conductor that is a conductor different from the first antenna conductor, the second antenna conductor not being connected to the target. In this case, the rectifier may rectify output from the antenna section.

The rectifier may include a coil rectifier circuit that rectifies the output from the coil section, and an antenna rectifier circuit that rectifies the output from the antenna section.

The rectifier may include a shared rectifier circuit that rectifies the output from the coil section and the output from the antenna section.

On the surface of the target, the first antenna conductor may be arranged further outward than a region, on the surface of the target, that the coil section faces. In this case, the second antenna conductor may be arranged parallel to the axis of the coil section.

The core may include a first end surface that faces the target, and a second end surface that is situated opposite to the first end surface. In this case, the first antenna conductor may be arranged to face the first end surface. Further, the second antenna conductor may be arranged to face the second end surface.

The energy harvester may further include a power storing section that charges, to a power storing element, power output from the rectifier.

An energy harvester includes a coil section, a maintaining portion, a rectifier, and a power storing section.

The coil section includes a core that is made of a magnetic material, and a wire rod that is wound around the core.

The maintaining portion maintains the coil section on a surface of a target that includes a metallic body or a human body, such that an axis of the coil section intersects the surface of the target.

The rectifier rectifies output from the coil section.

The power storing section charges, to a power storing element, power output from the rectifier.

### BRIEF DESCRIPTION OF DRAWINGS

FIG. 1 schematically illustrates an example of a configuration of an energy harvester according to a first embodiment of the present technology.

FIG. 2 is a block diagram illustrating an example of a functional configuration of the energy harvester.

FIG. 3 is a schematic diagram used to describe a magnetic field generated around a target.

FIG. 4 schematically illustrates an example of a configuration of a coil section.

FIG. 5 schematically illustrates an example of a configuration of a core of the coil section.

FIG. 6 illustrates data obtained by mapping a magnetic field that passes through the drum-shaped core.

FIG. 7 is a graph illustrating a relationship between a position of metal and a quality factor of the coil section.

FIG. 8 is a circuit diagram illustrating an example of a rectifier circuit.

FIG. 9 is a table in which a forward voltage and a reverse current with respect to a rectifier diode are given.

FIG. 10 is a graph of I-V curve measurement regarding the rectifier diode illustrated in FIG. 9.

FIG. 11 schematically illustrates how to use the energy harvester.

FIG. 12 illustrates examples of a specific configuration of and characteristics of the coil section.

FIG. 13 is a graph illustrating Vf-If characteristics of a backflow prevention diode.

FIG. 14 is a perspective view of an example of a configuration of a core of a coil section according to a second embodiment.

FIG. 15 schematically illustrates examples of configurations of energy harvesters that each include the core illustrated in FIG. 14.

FIG. 16 schematically illustrates an example of a configuration of an energy harvester according to a third embodiment.

FIG. 17 is a block diagram illustrating an example of a functional configuration of the energy harvester.

FIG. 18 is a schematic diagram used to describe an operation of an antenna section.

FIG. 19 schematically illustrates an example of a configuration of a second antenna conductor formed on a circuit board.

FIG. 20 schematically illustrates an example of a configuration of an energy harvester according to a fourth embodiment.

FIG. 21 is a block diagram illustrating an example of a functional configuration of an energy harvester according to a fifth embodiment.

FIG. 22 is a circuit diagram illustrating an example of how to connect a coil section and an antenna section to a rectifier circuit.

FIG. 23 is a circuit diagram illustrating an example of a configuration of an energy harvester that includes an isolation section.

FIG. 24 is a circuit diagram illustrating another example of the configuration of the energy harvester including the isolation section.

FIG. 25 is a set of circuit diagrams each illustrating an example of a configuration of a filter.

FIG. 26 schematically illustrates an example of an apparatus that includes an energy harvester that includes the isolation section.

FIG. 27 schematically illustrates an example of an apparatus that includes the energy harvester including the isolation section.

FIG. 28 schematically illustrates an example of an apparatus that includes the energy harvester including the isolation section.

FIG. 29 is a circuit diagram illustrating an example of a ground circuit of an apparatus that includes an energy harvester.

FIG. 30 is a circuit diagram illustrating an example of a ground circuit of the apparatus including the energy harvester.

FIG. 31 is a circuit diagram illustrating an example of a ground circuit of the apparatus including the energy harvester.

FIG. 32 is a set of circuit diagrams each illustrating an example of a configuration of a circuit for measures against short circuit.

FIG. 33 is a circuit diagram illustrating an example of a configuration of an energy harvester that is compatible with a high voltage.

FIG. 34 is a circuit diagram illustrating an example of a configuration of an ideal diode.

FIG. 35 is a circuit diagram illustrating another example of a configuration of an energy harvester.

FIG. 36 is a circuit diagram illustrating another example of a configuration of a rectifier circuit.

### MODE(S) FOR CARRYING OUT THE INVENTION

Embodiments according to the present technology will now be described below with reference to the drawings.

### First Embodiment

### [Configuration of Energy Harvester]

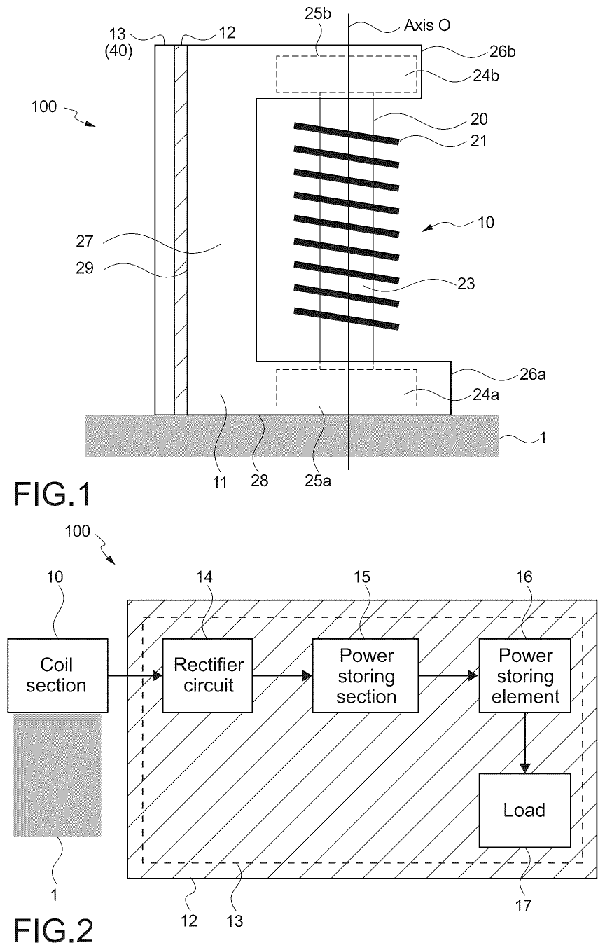

FIG. 1 schematically illustrates an example of a configuration of an energy harvester according to a first embodiment of the present technology. FIG. 2 is a block diagram illustrating an example of a functional configuration of an energy harvester 100.

The energy harvester 100 is an apparatus that draws energy of a magnetic field generated around, for example, a metallic body or a human body, and harvests the energy as power. In other words, it can also be said that the energy harvester 100 is an apparatus that performs energy harvesting using energy of a magnetic field present in a surrounding environment.

A metallic body or a human body for which the energy harvester 100 draws magnetic-field energy is hereinafter referred to as a target 1.

As illustrated in FIG. 1, the energy harvester 100 includes a coil section 10, a housing 11, a nonmagnetic body 12, and a circuit section 13. Further, the circuit section 13 includes a rectifier circuit 14, a power storing section 15, a power storing element 16, and a load 17, as illustrated in FIG. 2. Note that at least the rectifier circuit 14 is provided to the circuit section 13. Furthermore, for example, the power storing section 15, the power storing element 16, and the load 17 may each be provided separately from the circuit section 13, and the structural elements may be connected to each other as appropriate.

The coil section 10 is a coil that captures magnetic-field energy and outputs the magnetic-field energy as power. The coil section 10 includes a core 20 that is made of a magnetic material, and a wire rod 21 that is wound around the core 20. Further, an axis O is set for the coil section 10. The axis O is a coil axis that passes through a center of a loop formed by the wire rod 21 wound around the core 20.

When there is a change in a magnetic field inside of the loop formed by the wire rod 21, power depending on the change in the magnetic field is generated and output to a circuit (the rectifier circuit 14) connected to the wire rod 21.

The housing 11 is a case that accommodates therein the coil section 10. In the present embodiment, the housing 11 serves as a member that maintains the coil section 10 relative to the target 1. Specifically, the housing 11 maintains the coil section 10 on a surface of the target 1 including a metallic body or a human body, such that the axis O of the coil section 10 intersects the surface of the target 1.

Consequently, the magnetic field (magnetic flux) generated in a state of intersecting the surface of the target 1 passes through the loop formed by the wire rod 21 of the coil section 10. This makes it possible to pick up a change in magnetic field with certainty. In the present embodiment, the housing 11 corresponds to a maintaining portion.

The coil section 10 and the housing 11 will be described in detail later.

The nonmagnetic body 12 is a member that is made of a nonmagnetic material, and typically, the nonmagnetic body 12 is made of nonmagnetic metal. The nonmagnetic body 12 is arranged at a specified distance from the coil section 10. In the example illustrated in FIG. 1, a plate member is used as the nonmagnetic body 12.

The provision of the nonmagnetic body 12 makes it possible to reduce a deterioration in properties of the coil section 10 that is caused due to, for example, the circuit section 13. The distance between the nonmagnetic body 12 and the coil section 10 is set in, for example, a range that enables the coil section 10 to have necessary properties. A relationship between the nonmagnetic body 12 and the coil section 10 will be described in detail later.

The circuit section 13 includes the rectifier circuit 14, the power storing section 15, the power storing element 16, and the load 17, as described above. Further, the circuit section 13 is arranged across the nonmagnetic body 12 from the coil section 10.

As illustrated in FIG. 1, the circuit section 13 includes a circuit board 40 on which a plurality of circuits including the rectifier circuit 14 is formed. The nonmagnetic body 12 is arranged between the circuit board 40 and the coil section 10. More specifically, the circuit board 40 is connected to a surface of the nonmagnetic body 12 that is situated opposite to a surface of the nonmagnetic body 12 that faces the coil section 10.

Note that FIG. 2 schematically illustrates a hatched region that corresponds to the nonmagnetic body 12, the hatched region being formed by surrounding the structural elements of the circuit section 13.

The rectifier circuit 14 is a circuit that rectifies output from the coil section 10. For example, alternating-current power depending on a change in magnetic flux is output by the coil section 10. The rectifier circuit 14 rectifies alternating-current power to convert the alternating-current power into direct-current power. In the present embodiment, the rectifier circuit 14 corresponds to a rectifier.

In the energy harvester 100, a power receiver that receives, as power, energy of a magnetic field generated around the target 1 is formed by the coil section 10 and the rectifier circuit 14.

The power storing section 15 is a circuit that charges the power storing element 16. The power storing section 15 charges, to the power storing element 16, power output by the rectifier circuit 14. The power storing section 15 outputs power that is necessary to perform charging, according to, for example, a charging state of the power storing element 16. Note that, for example, the power charged to the power storing element 16 may correspond to output from the rectifier circuit 14 itself, or may correspond to, for example, power stored in, for example, a capacitor.

The power storing element 16 is an element that stores therein power (power received by the coil section 10) rectified by the rectifier circuit, and supplies power to the load 17 as necessary. For example, a capacitor or a secondary battery is used as the power storing element 16.

As described above, the energy harvester 100 serves as a charging apparatus that charges output from the coil section 10 to the power storing element 16 through the rectifier circuit 14 and the power storing section 15.

The load 17 is a circuit or element that is driven by power supplied by the power storing element 16. For example, a control unit such as a microcomputer, a communication unit, or any sensor is used as the load 17.

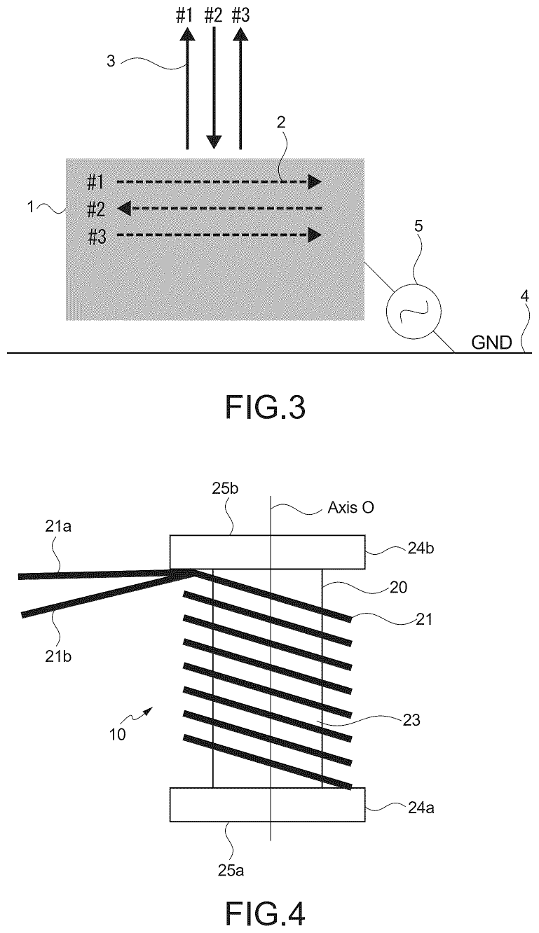

FIG. 3 is a schematic diagram used to describe a magnetic field generated around the target 1. FIG. 3 schematically illustrates, using a dotted arrow, current 2 that flows through the target 1. An orientation of the dotted arrow indicates an orientation of the current. Further, a magnetic field 3 that is generated by the current 2 is schematically illustrated using a solid arrow. An orientation of the solid arrow indicates an orientation of the magnetic field 3 (magnetic flux).

Generally, the magnetic field 3 is generated to surround a conductor such as metal when the current 2 flows through the conductor. This is the so-called Ampere's law. Thus, the magnetic field 3 depending on the current 2 is generated around the target 1 through which the current 2 flows. Here, the orientation of the magnetic field 3 is reversed in response to the orientation of the current 2 being reversed.

With respect to, for example, home appliances, there is a potential difference between the potential of a home appliance and the earth potential in principle unless the home appliance is forcibly grounded to an earth GND (an earth ground 4).

Further, most home appliances use power obtained by alternating-current power being converted into direct-current power. When, for example, power is converted into direct current from alternating current, a pulse signal that has a positive (+) potential and a negative (−) potential may be generated. Further, various clock frequencies are used to, for example, convert power for home appliances, and there may be a variation in a GND itself that is provided to a circuit of a home appliance.

This results in a potential difference between the home appliance and the earth ground 4, and alternating currents of various frequencies flow through the home appliance.

In the example illustrated in FIG. 3, the target 1 is above the earth ground 4, and the current 2 corresponding to alternating current flows through the target 1. It can also be said that a virtual alternating-current power supply 5 is connected between the target 1 and the earth ground 4, as illustrated in FIG. 3.

The current 2 flowing through the target 1 is current that is oriented alternately in different directions. For example, the current 2 is a bundle of alternating currents of various frequencies. However, the description is made here on the assumption that alternating current that varies at a certain frequency is generated.

When, for example, the current 2 flows from the left to the right in the figure, as shown with #1, the magnetic field 3 oriented upward in the figure is generated. Next, when there is a change in the orientation of the current and the current 2 flows from the right to the left in the figure, as shown with #2, the magnetic field 3 oriented downward in the figure is generated. Thereafter, when there is a change in the orientation of the current again and the current 2 flows from the left to the right in the figure, as shown with #3, the magnetic field 3 oriented upward in the figure is generated, as in the case of #1.

As described above, in a direction of passing through the surface of the target 1, the magnetic field 3 of alternating current is generated around the target 1 situated above the earth ground 4 by the current 2 corresponding to alternating current and flowing through the target 1.

Note that, for example, the magnetic field 3 generated by the current 2 exhibits an annular distribution that is rotated about the current 2. Thus, the orientations of the current 2 and the magnetic field 3 that are illustrated in FIG. 3 may be switched depending on a place at which the magnetic field 3 is generated.

Further, when an electric field present in a space acts on the target 1, the current 2 corresponding to alternating current may be induced in the target 1, and the magnetic field 3 may be generated around the target 1. Examples of the electric field acting on the target 1 include electric fields of various frequencies, such as radio waves propagating through a region situated around the target 1 and a quasi-electrostatic field generated around the target 1. Due to such electric fields, the current 2 corresponding to alternating current may be induced in the target 1 such as a human body or metallic rack that is not connected to, for example, an alternating-current power supply. In this case, the magnetic field 3 depending on the current 2 induced due to an electric field is generated around the target 1.

For example, it is sufficient if the target 1 is an object in which the current 2 corresponding to alternating current is induced to generate the magnetic field 3. As described above, the target 1 includes a metallic body or a human body. Examples of the metallic body include industrial products familiar with the public (such as vehicle, vending machine, refrigerator, microwave, metal rack, guard rail, mailbox, and traffic light) and metallic objects.

The metallic body is above the earth ground 4 in order to draw power. The metallic body may be made of any metal such as iron, aluminum, copper, or a metallic alloy, and the type of material is not limited if the material is metal.

When a variation in the magnetic field 3 is efficiently converted into energy on the surface of the target 1 around which the magnetic field 3 is generated, the energy can be used as power, as described above. The energy harvester 100 is intended for such a magnetic-field energy. A configuration of each structural element of the energy harvester 100 is specifically described below.

### [Coil Section]

FIG. 4 schematically illustrates an example of a configuration of the coil section 10.

The coil section 10 is formed by the wire rod 21 being wound around the core 20. Note that the wire rod 21 may be directly wound around the core 20, or another member may be provided between the core 20 and the wire rod 21. When, for example, the housing 11 made of resin is formed using a technique such as molding, the entirety of the core 20 may also be covered with resin. In this case, the wire rod 21 is wound around the core 20 coated with resin.

As described above, the core 20 of the coil section 10 is made of a magnetic material. Consequently, the core 20 exhibiting a high magnetic permeability is arranged inside of the coil, and thus the quality factor of the coil is improved.

Here, the quality factor of a coil is an indicator that indicates a relationship between retention and loss of energy in the coil. For example, a higher quality factor indicates a smaller energy loss. Thus, an increase in the quality factor of the coil section 10 makes it possible to efficiently capture magnetic-field energy.

Typically, the magnetic material of the core 20 is soft ferrite.

The soft ferrite is insulating ceramics that has soft magnetic properties. The soft ferrite has a low retention ability to retain magnetic force, and exhibits a high magnetic permeability. Thus, the magnetic force will be lost if there is no external magnetic field. However, the magnetic flux density is increased and magnetization is performed strongly while an external magnetic field is acting. Further, the soft ferrite can be magnetized in response to magnetic fields over a wide range of frequencies.

Thus, the use of the core 20 made of soft ferrite makes it possible to efficiently capture energy of magnetic fields over a wide range of frequencies. This results in greatly improving the efficiency in capturing magnetic-field energy.

Further, the magnetic permeability exhibits a frequency response. Thus, for example, a material that exhibits a high magnetic permeability at a frequency of a capturing-target magnetic field is favorably selected as soft ferrite of the core 20. Thus, the type of soft ferrite is selected according to the frequency of noise (alternating current) to be received. For example, Mn—Zn—based soft ferrite is used for a frequency range of from 50 Hz to several megahertz. Further, Ni—Zn-based soft ferrite is used for a frequency of several megahertz or more.

It is conceivable that, when, for example, a home appliance using a commercial power supply is the target 1, alternating current in a band of relatively low frequencies such as 50 Hz or 60 Hz could be generated. In such a case, Mn—Zn-based soft ferrite exhibiting a high magnetic permeability is used. Further, Ni—Zn-based soft ferrite is used for the target 1 in which alternating current of several megahertz or more is induced.

For example, the wire rod 21 of the coil section 10 is a litz wire that is a single electric wire obtained by twisting together a plurality of thin wires insulated from each other. For example, a litz wire that has a wire diameter q of 1.0 mm and is obtained by bundling fifteen thin wires each having a wire diameter q of 0.2 mm and being made of soft copper is used as the wire rod 21. The use of a litz wire makes it possible to obtain a high quality-factor even in a frequency domain in which the skin effect is exhibited. Note that a specific configuration of the wire rod 21 is not limited, and, for example, a single wire rod 21 may be used.

The wire rod 21 is wound around the core 20 (an axial portion 23 described later) a specified number of turns. Here, a method for winding the wire rod 21 is alpha winding. In other words, the wire rod 21 is an alpha-wound winding.

The alpha winding is a winding method including winding, around an outer periphery of the coil, a portion of the wire rod 21 that is wound upon starting winding and a portion of the wire rod 21 that is wound upon finishing winding. For example, an alpha-wound winding is formed by winding two ends of the wire rod 21 outward at the same time. This results in one of the two ends of wire rod 21 not being left in the wound wire and thus in increasing a space factor of the wire rod 21. This makes it possible to improve a performance such as the quality factor of the coil.

Note that the method for winding the wire rod 21 is not limited to the alpha winding, and any other winding methods may be used.

In the coil section 10, the core 20 is formed using a magnetic material (here, soft ferrite), and a litz wire is wound around the core 20 (the axial portion 23) using alpha winding, as described above. This results in improving the quality factor.

The two ends of the wire rod 21 are hereinafter respectively referred to as a first coil terminal 21a and a second coil terminal 21b.

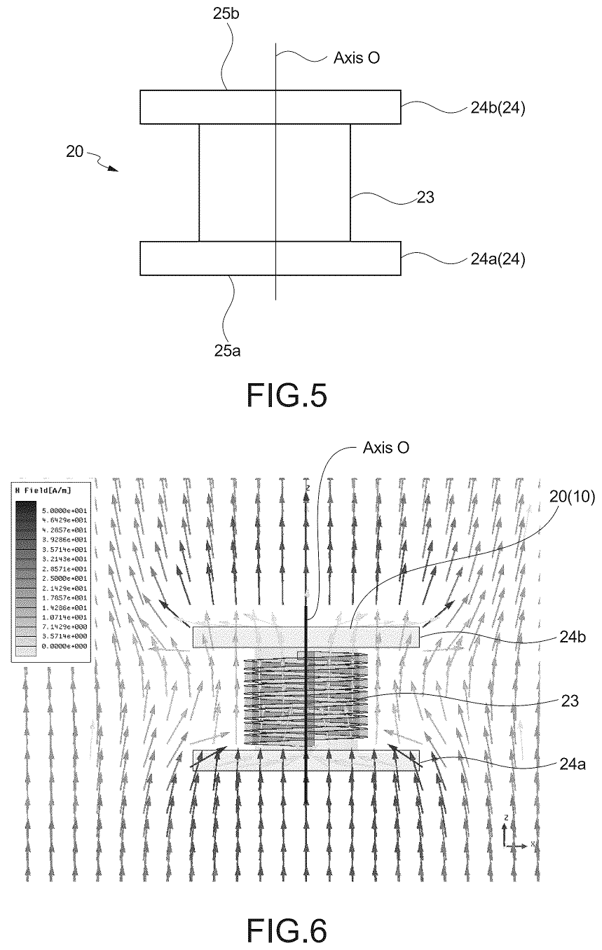

FIG. 5 schematically illustrates an example of a configuration of the core 20 of the coil section 10. As illustrated in FIG. 5, the core 20 includes the axial portion 23 and a pair of flange portions 24.

The axial portion 23 is a portion around which the wire rod 21 is wound, and is a solid member that is filled into a space inside of a loop formed by the wire rod 21. The axial portion 23 has a columnar shape that extends in parallel with the axis O of the coil section 10, and the wire rod 21 is wound around a peripheral surface of the axial portion 23. For example, a cylindrical shape, a polygonal-prism shape such as a quadrangular-prism shape, or an elliptical shape is used as the shape of the axial portion 23.

The paired flange portions 24 are respectively provided at two ends of the axial portion 23, where flanges are formed that each protrude further outward than the peripheral surface of the axial portion 23. Thus, the core 20 has a dram shape (an H shape) obtained by the axial portion 23 being situated between the paired flange portions 24. Each flange portion 24 includes a flat surface having, for example, a circular shape, a polygonal shape such as a quadrilateral shape, or an elliptical shape. The flange portion 24 may have a flat surface having a shape obtained by enlarging a cross section of the axial portion 23, or a shape that conforms to, for example, the shape of the housing 11 may be used as the shape of the flat surface. Note that the flange portion 24 does not necessarily have to be provided, and, for example, the core 20 may have a structure with no flange portion 24.

Further, the housing 11 maintains the coil section 10 such that one of the pair of flange portions 24 faces the target 1. One of the pair of flange portions 24 that faces the target 1 is hereinafter referred to as a first flange portion 24a, and another of the pair of flange portions 24 that is situated across the axial portion 23 from the target 1 and faces a direction opposite to the target 1 is hereinafter referred to as a second flange portion 24b. Here, the flange portion 24 in a lower portion in the figure and the flange portion 24 in an upper portion in the figure are respectively referred to as the first flange portion 24a and the second flange portion 24b.

Further, the core 20 of the coil section 10 includes a first end surface 25a that faces the target 1, and a second end surface 25b that is situated opposite to the first end surface 25a. In the present embodiment, one of surfaces of the first flange portion 24a that is situated opposite to another of the surfaces of the first flange portion 24a that is connected to the axial portion 23, is the first end surface 25a. Further, one of surfaces of the second flange portion 24b that is situated opposite to another of the surfaces of the second flange portion 24b that is connected to the axial portion 23, is the second end surface 25b.

FIG. 6 illustrates data obtained by mapping a magnetic field that passes through the drum-shaped core 20. Arrows that represent magnetic flux (a magnetic field) are mapped onto a plane that includes the axis O of the coil section 10. An orientation of each arrow indicates an orientation of the magnetic field at a corresponding point, and a color of each arrow represents a strength (A/m) of the magnetic field at a corresponding point.

The wire rod 21 is wound around the core 20 to form the coil section 10. Further, it is assumed that the axis O of the coil section 10 extends in parallel with an up-and-down direction (a Z direction) in the figure, and that an external magnetic field that is oriented upward in the figure is generated in that state. Thus, magnetic flux that enters the core 20 through the first flange portion 24a on a lower side of the core 20 goes out through the second flange portion 24b on an upper side of the core 20.

As illustrated in FIG. 6, on the lower side of the core 20, the magnetic flux is deflected to be concentrated onto the first flange portion 24a protruding further outward than the axial portion 23. Further, on the lower side of the core 20, the magnetic flux is deflected to widespreadly go out through the second flange portion 24b protruding further outward than the axial portion 23.

In other words, the magnetic flux is deflected to be concentrated onto the axial portion 23 in the drum-shaped core 20. As described above, when the core 20 has a drum shape, magnetic flux can be collected from a region situated around the core 20, and this makes it possible to make a magnetic field generated inside of the core 20 stronger. This makes it possible to efficiently capture energy of a magnetic field generated around the target 1 such as metal or a human body.

### [Housing]

The housing 11 maintaining the coil section 10 is described below with reference to FIG. 1.

The housing 11 includes a first end portion 26a, a second end portion 26b, and a lateral portion 27. The first end portion 26a and the second end portion 26b are plate members that are each orthogonal to the axis O of the coil section 10 and that are arranged to face each other. The lateral portion 27 is a plate member that extends in parallel with the axis O of the coil section 10, and connects the first end portion 26a and the second end portion 26b. In the present embodiment, the first end portion 26a and the second end portion 26b respectively protrude in the same direction from two ends of the lateral portion 27 in the form of a plate to form the housing 11 having a U shape, as illustrated in FIG. 1.

As described above, the housing 11 accommodates therein the coil section 10. For example, the housing 11 is formed such that at least a portion of the coil section 10 is situated in the housing 11 or in a space formed by the housing 11.

In the example illustrated in FIG. 1, the first flange portion 24a is embedded in the first end portion 26a, and the second flange portion 24b is embedded in the second end portion 26b. Further, the axial portion 23 around which the wire rod 21 is wound is arranged in a space situated between the first end portion 26a and the second end portion 26b. In FIG. 1, the coil section 10 is accommodated in a space that is formed in the U-shaped housing 11, as described above.

The housing 11 is made of, for example, a resin material such as plastic, and is formed using a technique such as molding. In this case, a resin material is filled into a mold in a state in which the core 20 is arranged in the mold. Accordingly, the housing 11 is formed. Alternatively, the core 20 may be fitted into the housing 11 after the housing 11 is formed.

Further, a configuration of the housing 11 is not limited to the example illustrated in FIG. 1. For example, the housing 11 covering the entirety of the core 20 including the axial portion 23 may be formed. In this case, the wire rod 21 is wound around a resin material that covers the axial portion 23. Further, the housing 11 in which the core 20 around which the wire rod 21 is wound is covered with a resin material, may be formed.

In the present embodiment, the housing 11 is attached to the surface of the target 1. In other words, the housing 11 can be fixed in contact with, or closely to the surface of the target 1. A surface of the housing 11 that faces the surface of the target 1 is hereinafter referred to as an attachment surface 28. The attachment surface 28 is a surface that is in contact with, or close to the surface of the target 1.

In the housing 11 illustrated in FIG. 1, a surface that is included in the first end portion 26a in the form of a plate and faces outward (is situated opposite to the second end portion 26b) is the attachment surface 28. The attachment surface 28 is flat in principle. However, a curved shape such as a concave or a convex may be used in conformity to, for example, a shape of the surface of the target 1.

An attachment mechanism (not illustrated) used to attach the housing 11 to the surface of the target 1 is provided to the housing 11. A band, an adhesive tape, a mechanism used to fasten with a screw, a magnet, a clip, a fitting groove, a suction cup, or an adhesive is used as the attachment mechanism. Moreover, any fixing device with which the housing 11 can be attached to the surface of the target 1 may be used.

When, for example, the target 1 is, for example, a home appliance, the housing 11 is fixed by the attachment surface 28 being brought into contact with the exterior of the home appliance. Further, when the target 1 is a human body, the housing 11 is formed to have a size that enables the housing 11 to be attached to a man, and is fixed by the attachment surface 28 being brought into contact with the skin of the human body or the surface of clothing.

Further, the housing 11 maintains the coil section 10 such that the axis O of the coil section 10 and the attachment surface 28 are orthogonal to each other, as illustrated in FIG. 1. This makes it possible to arrange the coil section 10 in a state in which the axis O of the coil section 10 is orthogonal to the surface of the target 1.

For example, an orientation of a magnetic field generated by current flowing through the target 1 is orthogonal to a direction in which the current flows, as described with reference to FIG. 3. Thus, a magnetic field is generated around the surface of the target 1 principally in a direction that is orthogonal to the surface of the target 1. Therefore, the direction in which there is a change in magnetic field is the direction orthogonal to the surface of the target 1 (a direction normal to the surface of the target 1).

When the axis O of the coil section 10 is caused to extend in parallel with the direction in which there is a change in magnetic field, this results in improving the efficiency in capturing magnetic-field energy. In the present embodiment, when the axis O of the coil section 10 is orthogonal to the attachment surface 28, this results in the axis O of the coil section 10 being orthogonal to the surface of the target 1, and in the axis O of the coil section 10 extending in parallel with the direction in which there is a change in magnetic field. This makes it possible to capture magnetic-field energy without waste.

Further, the housing 11 may maintain the coil section 10 such that an end surface (the first end surface 25a) of the core 20 that faces the target 1 and the attachment surface 28 coincide in a direction in which the axis O of the coil section 10 extends. Thus, the housing 11 may be formed such that the first end surface 25a of the first flange portion 24a is exposed to serve as the attachment surface 28. Alternatively, the first end surface 25a may protrude toward the target 1 from the housing 11.

Consequently, the surface of the target 1 and the core 20 get close to each other, and a magnetic field can be concentrated onto a portion in which the magnetic field is strong (in which the magnetic flux density is high). This makes it possible to efficiently capture magnetic-field energy.

### [Nonmagnetic Body]

The nonmagnetic body 12 is a plate member or sheet member that is arranged at a certain distance from the coil section 10. As illustrated in FIG. 1, a lateral surface 29 that is a surface situated opposite to another surface of the lateral portion 27 that faces the coil section 10, is formed on the lateral portion 27 of the housing 11. The nonmagnetic body 12 is fixed to the lateral surface 29 of the housing 11. A method for fixing the nonmagnetic body 12 to the lateral surface 29 is not limited, and, for example, a technique such as bonding, fastening with a screw, or fitting may be used.

In this configuration, a distance between the lateral surface 29 of the housing 11 and the coil section 10 (for example, a distance from the axis O of the coil section 10 to the lateral surface 29) corresponds to a distance between the coil section 10 and the nonmagnetic body 12.

It is known that, in general, the quality factor of a coil is degraded when there is other metal (such as wiring of a circuit or the exterior of an element) around the coil. The reason is that a distribution of a magnetic field is deteriorated due to the magnetic field being attracted by the other metal, or magnetic-field energy is consumed due to, for example, heat being generated by an eddy current.

In the energy harvester 100, there is a need to reduce an impact of other metal situated near the coil section 10 in order to efficiently receive an alternating-current magnetic field (refer to FIG. 3) generated around the surface of the target 1 and to perform conversion into power.

The nonmagnetic body 12 enables a magnetic field (magnetic flux) to flow to move to a location at a certain distance from the coil section 10. This prevents a magnetic field situated around the coil section 10 from being attracted by other metal that is included in the circuit section 13. This results in providing an effect of maintaining flow of the magnetic field properly. Further, the nonmagnetic body 12 results in a smaller magnetic-field-energy loss caused by an eddy current, compared to, for example, ferromagnetic metal. This makes it possible to sufficiently reduce a degradation in quality factor. As described above, the coil section 10 is covered with the nonmagnetic body 12 situated at a certain distance from the coil section 10. This makes it possible to reduce an impact of the circuit section 13.

In the present embodiment, the nonmagnetic body 12 is formed to cover a surface of the circuit board 40 described later that faces the coil section 10. Thus, the coil section 10 is not visible as viewed from the circuit board 40 since the coil section 10 is completely blocked by the nonmagnetic body 12. For example, the nonmagnetic body 12 is formed to have the same shape and the same size as the circuit board 40. Alternatively, the nonmagnetic body 12 may be formed to have a larger flat surface than the circuit board 40. This makes it possible to sufficiently reduce an impact that metal included in the circuit board 40 (the circuit section 13) has on the coil section 10.

Further, the nonmagnetic body 12 is arranged parallel to the axis O of the coil section 10. In the example illustrated in FIG. 1, the lateral surface 29 of the housing 11 is a surface parallel to the axis O of the coil section 10, and the nonmagnetic body 12 is arranged along the lateral surface 29. Note that, when the lateral surface 29 is inclined with respect to the axis O of the coil section 10, the nonmagnetic body 12 may be attached to the lateral surface 29 in a state in which the nonmagnetic body 12 is inclined with respect to the lateral surface 29, such that the nonmagnetic body 12 is parallel to the axis O of the coil section 10.

When the nonmagnetic body 12 is arranged parallel to the axis O of the coil section 10, this enables a magnetic field distributed along the axis O of the coil section 10 to flow without greatly changing an orientation of the magnetic field. This makes it possible to sufficiently reduce a degradation in the quality factor of the coil section 10. Further, the nonmagnetic body 12 is in a pose that enables the nonmagnetic body 12 to be parallel to the axis O of the coil section 10. This results in, for example, the quality factor of the coil section 10 being less likely to be affected by the nonmagnetic body 12 getting close to the coil section 10. This makes it possible to make the apparatus compact.

Typically, aluminum is used for the nonmagnetic body 12. This makes it possible to make the apparatus light in weight. Further, copper may be used for the nonmagnetic body 12. Moreover, any other nonmagnetic metal may be used.

Further, in the present embodiment, a plate member having a thickness of, for example, greater than or equal to 0.3 mm is used as the nonmagnetic body 12. The thickness of about 0.3 mm makes it possible to sufficiently reduce a degradation in the quality factor of the coil section 10. Of course, the nonmagnetic body 12 having a thickness of 0.5 mm or 1 mm may be used. Further, if the level of degradation in quality factor is in an acceptable range, the nonmagnetic body 12 having a thickness of less than 3 mm may be used.

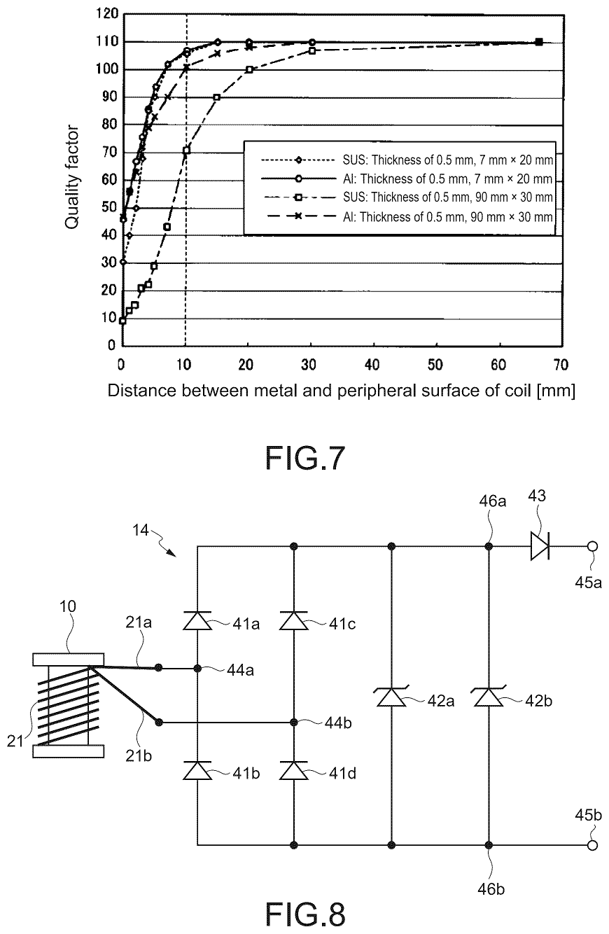

FIG. 7 is a graph illustrating a relationship between a distance between a plate (the nonmagnetic body 12) made of metal of a nonmagnetic material and the coil section 10, and the quality factor. Here, a change in quality factor that is caused when the metallic plate is arranged parallel to the coil section is described.

A horizontal axis of the graph represents a distance between metal and a peripheral surface of the coil section 10. A vertical axis of the graph represents the quality factor of the coil section 10. Data illustrated in FIG. 7 was obtained by measuring the quality factor for different positions of a plate made of aluminum (Al) and different positions of a plate made of stainless steel (SUS). The plates on which measurement was performed each had a thickness of 0.5 mm, and, for each type of material, measurement was performed on a plate having a size of 7 mm×20 mm and a plate having a size of 90 mm×30 mm.

As illustrated in FIG. 7, the quality factor of the coil section 10 tends to be degraded when there is a metallic plate near the coil section 10, and the quality factor is more degraded if the metallic plate has a larger area. Further, with respect to the type of metallic material, the quality factor of aluminum is less degraded than the quality factor of stainless. Compared to stainless steel based on iron that is a magnetic material, a line of magnetic force is less likely to be accumulated in a single nonmagnetic material made of, for example, aluminum or copper, and this results in an eddy current not easily flowing through the single nonmagnetic material. As described above, the result illustrated in FIG. 7 shows that aluminum has a smaller impact on the quality factor than stainless steel, although aluminum and stainless steel are both nonmagnetic materials. Further, the result shows that when, for example, a metallic plate made of a nonmagnetic material is arranged at a distance of about 10 mm from a coil formed by winding performed around a core, this results in a smaller impact on the quality factor.

When the nonmagnetic body 12 is arranged near the coil section 10, the quality factor may be degraded conversely if the nonmagnetic body 12 is situated too close to the coil section 10. Thus, the distance between the nonmagnetic body 12 and the coil section 10 is set such that the level of degradation in quality factor is in an acceptable range. Note that the quality factor of the coil section 10 may be measured using, for example, an LCR meter or a quality meter.

An arrangement distance between the nonmagnetic body 12 and the coil section 10 is set to be a distance such that, for example, the quality factor of the coil section 10 is degraded by 20% to 30%, compared with the quality factor obtained when the nonmagnetic body 12 is not arranged. This makes it possible to make the apparatus compact while maintaining a sufficient level of quality factor. Further, the distance may be set such that, for example, the quality factor is degraded by 10% or less, compared with the quality factor obtained when the nonmagnetic body 12 is not arranged. This makes it possible to sufficiently improve the efficiency in capturing magnetic-field energy.

Note that, when the circuit section 13 is not arranged near the coil section 10, the nonmagnetic body 12 does not necessarily have to be provided. When, for example, the circuit section 13 is provided separately from the housing 11 accommodating therein the coil section 10 and no metal that blocks a magnetic field is situated near the coil section 10, the nonmagnetic body 12 does not have to be provided.

### [Circuit Section and Rectifier Circuit]

In the present embodiment, the circuit section 13 includes the circuit board 40 in the form of a flat plate, the circuit board 40 being arranged along the nonmagnetic body 12. The circuit board 40 is a mounting board that is made of, for example, glass epoxy and on which various circuits are provided. The circuit board 40 is arranged across the nonmagnetic body 12 from the coil section 10 in contact with, or closely to the nonmagnetic body 12.

The circuit board 40 includes the rectifier circuit 14, the power storing section 15, and the power storing element 16, which are used to operate the energy harvester 100; various sensors corresponding to the load 17; and communication apparatuses such as Bluetooth (registered trademark) Low Energy (BLE) used to transmit data to the outside. The circuit board 40 is arranged along the nonmagnetic body 12, and this makes it possible to mount the various circuits described above without any impact on reception of energy that is performed by the coil section 10.

The rectifier circuit 14 provided to the circuit board 40 is specifically described below.

FIG. 8 is a circuit diagram illustrating an example of the rectifier circuit. As illustrated in FIG. 8, the rectifier circuit 14 is a full-wave rectifier circuit.

The rectifier circuit 14 includes four diodes 41a to 41d, two Zener diodes 42a and 42b, a backflow prevention diode 43, and output terminals 45a and 45b.

The diodes 41a and 41b are connected in series, with the diode 41a being situated at the beginning in a forward direction. Further, a connection point 44a is provided between the diodes 41a and 41b. The diodes 41c and 41d are connected in series, with the diode 41c being situated at the beginning in the forward direction. Further, a connection point 44b is provided between the diodes 41c and 41d.

Respective cathodes of the diode 41a, the diode 41c, the Zener diode 42a, and the Zener diode 42b are connected to an anode of the backflow prevention diode 43. Further, a cathode of the backflow prevention diode 43 is connected to the output terminal 45a.

Respective anodes of the diode 41b, the diode 41d, the Zener diode 42a, and the Zener diode 42b are connected to the output terminal 45b.

The first coil terminal 21a of the coil section 10 is connected to the connection point 44a being situated between the diodes 41a and 41b. The second coil terminal 21b of the coil section 10 is connected to the connection point 44b of the diodes 41c and 41d.

For example, alternating-current magnetic field detected by the coil section 10 is output through the first and second coil terminals 21a and 21b as alternating-current power. The alternating-current power is full-wave rectified by the four diodes 41a to 41d to be output as direct-current power through the output terminals 45a and 45b. As described above, the rectifier circuit 14 illustrated in FIG. 8 is formed using the smallest diodes 41a to 41d necessary for full-wave rectification. This makes it possible to reduce unnecessary leakage current, and thus to sufficiently improve the efficiency in capturing magnetic-field energy.

The Zener diode 42a is an element used to cause, for example, static electricity applied at the first and second coil terminals 21a and 21b to escape. When a high voltage such as static electricity is caused, the Zener diode 42a serves as an electrostatic protection component used to cause static electricity to escape.

Further, the Zener diode 42b is an element used to protect, for example, an IC circuit (such as the power storing section 15) that is situated on an output side of the rectifier circuit 14 and connected to the output terminals 45a and 45b. When, for example, voltage caused between the first and second coil terminals 21a and 21b is greater than or equal to 6.5 V, the Zener diode 42b serves as a low-resistance conductor. This makes it possible to prevent a circuit situated on the output side from getting broken.

Further, the backflow prevention diode 43 is a diode that prevents current backflow.

The provision of the backflow prevention diode 43 makes it possible to prevent current backflow upon voltage reduction in the coil section 10, and thus to operate a circuit situated on the output side stably.

Note that a configuration of the rectifier circuit 14 is not limited. For example, a voltage doubler rectifier circuit or voltage quadrupling rectifier circuit that multiplies voltage using a capacitor, or a rectifier circuit into which a Cockcroft-Walton circuit is incorporated, may be used. Further, for example, a half-wave rectifier circuit may be used. Moreover, the rectifier circuit 14 may be formed as appropriate according to, for example, characteristics of power reception performed by the coil section 10 or characteristics of an element or circuit that is used as the load 17.

Here, characteristics of rectifier diodes 41a to 41d are described.

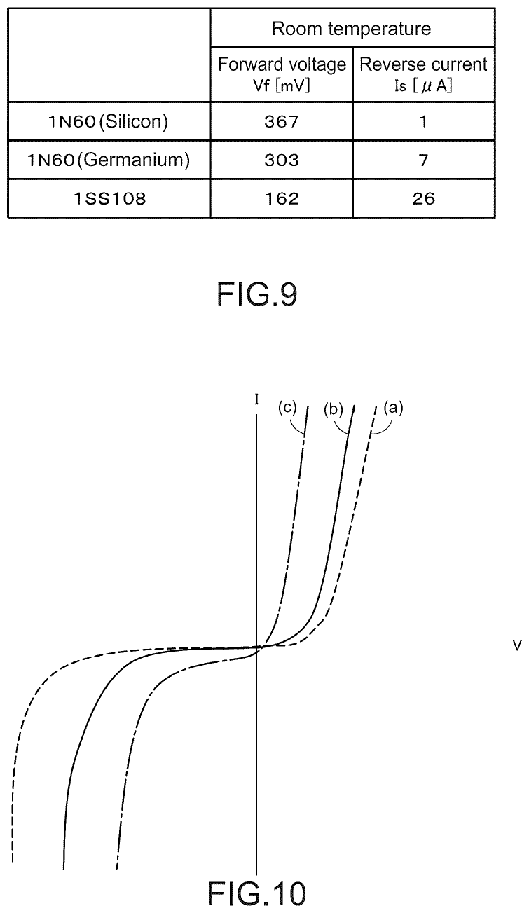

FIG. 9 is a table in which a forward voltage Vf and a reverse current Is with respect to the rectifier diode are given. FIG. 10 is a graph of I-V curve measurement regarding the rectifier diode illustrated in FIG. 9.

Measurement and estimation were performed using a silicon diode and a germanium diode with the product number 1N60 for rectifier diodes, and using a germanium diode with the other product number ISS108 for rectifier diodes that is manufactured by a different manufacturer. In FIG. 10, a curve (a) represents characteristics of 1N60 (silicon), a curve (b) represents characteristics of 1N60 (germanium), and curve (c) represents characteristics of ISS108 (germanium).

The reverse current Is is current that flows when voltage is applied in a reverse direction of a diode. Measurement data illustrated in FIG. 9 is data obtained when a voltage of 10 V is applied in the reverse direction of the diode. The forward voltage Vf is voltage applied when forward current (1 mA) starts flowing through the diode.

It has turned out that, when output from the coil section 10 is rectified, the diode 1N60 (silicon) through which smaller current flows in the reverse direction can capture more power than diodes through which current starts flowing in the forward direction when a lower voltage is applied. The rectified input is alternating current. Thus, the reverse current Is flowing when the forward voltage Vf of a diode is applied in the reverse direction was estimated. Considering that data of the reverse current Is that is illustrated in FIG. 9 was obtained when a voltage of 10 V is applied, the reverse current Is flowing when the same voltage as Vf is applied in the reverse direction is calculated from the data. 0.036 μA is obtained for 1N60 (silicon), 0.21 μA is obtained for 1N60 (germanium), and 0.5 μA is obtained for ISS108 (germanium).

Thus, when a ratio of the reverse current Is upon applying the forward voltage Vf to the forward current (1 mA) is calculated, 1/27778 is obtained for 1N60 (silicon), 1/4762 is obtained for 1N60 (germanium), and 1/2000 is obtained for ISS108 (germanium). In other words, with respect to the ratio described above, there is a need to use, for the rectifier circuit 14, a rectifier diode (41a to 41d) in which the forward current is about 4700 times greater than, or is favorably 10000 times greater than the reverse current upon applying the forward voltage. The result shows that, from among the three diodes described above as examples, the diode of 1N60 (silicon) has the most suitable characteristics.

Further, with respect to characteristics of a diode, it is better if a smaller reverse current Is flows upon applying voltage in the reverse direction. When a reverse resistance value is calculated using data obtained upon applying a voltage of 10V, 100 MΩ is obtained for 1N60 (silicon), 1.43 MΩ is obtained for 1N60 (germanium), and 0.38 MΩ is obtained for ISS108 (germanium). In other words, it is better if a value of resistance that prevents current from flowing in the reverse direction is larger. There is a need to use, for the rectifier circuit 14, a rectifier diode (41a to 41d) that exhibits a reverse resistance value of greater than 1.43 MΩ, and favorably a reverse resistance value of greater than or equal to 10 MΩ. The result shows that, from among the three diodes described above as examples, the diode of 1N60 (silicon) has the most suitable characteristics.

### [Example of how to Use Energy Harvester]

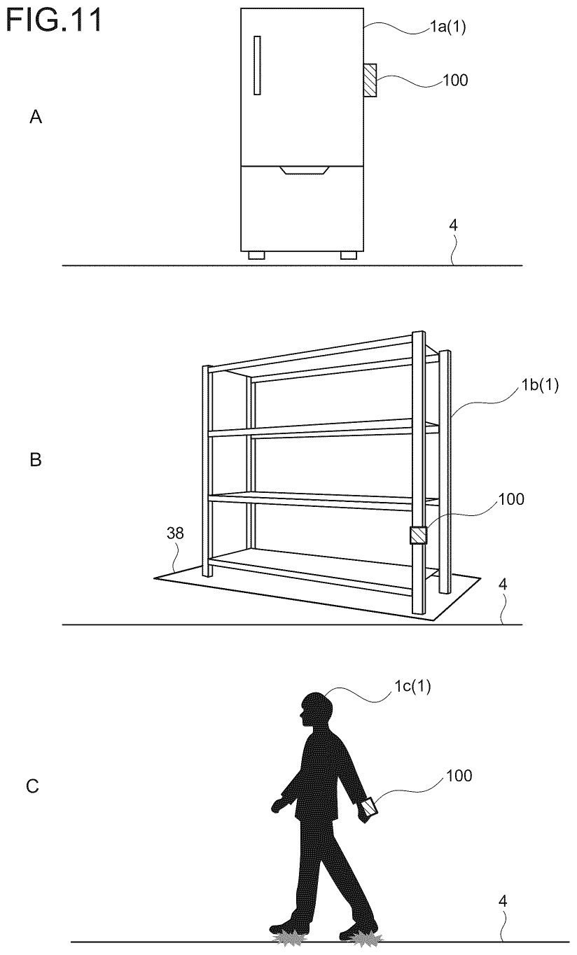

FIG. 11 schematically illustrates how to use the energy harvester.

In A of FIG. 11, the target 1 is a refrigerator 1a that is a home appliance, and the energy harvester 100 is attached to the exterior of the refrigerator 1a. The exterior of the refrigerator 1a is formed using, for example, a metallic plate, and the energy harvester 100 is attached thereto using, for example, a magnet. Further, the refrigerator 1a includes portions (such as the exterior and a frame) that are above the earth GND (the earth ground 4). In this case, alternating current depending on, for example, a home alternating-current power supply is induced in the refrigerator 1a, and an alternating-current magnetic field is generated on the surface of the refrigerator 1a. This magnetic field is captured by the energy harvester 100 as power.

In B of FIG. 11, the target 1 is a steel rack 1b that is a metallic body, and the energy harvester 100 is attached to a leg (a frame) of the steel rack 1b. The steel rack 1b is arranged on a carpet 38, and is above the earth ground 4. In this case, electric fields generated due to radio waves propagating through a region situated around the steel rack 1b, power supply noise, and the like act on the steel rack 1b to induce alternating current, and an alternating-current magnetic field is generated on the surface of the steel rack 1b. This magnetic field is captured by the energy harvester 100 as power.

In C of FIG. 11, the target 1 is a human body 1c, and the energy harvester 100 is worn on a wrist of the human body 1c using, for example, a band. For example, shoes are worn on the human body 1a, and the human body 1a is above the earth ground 4. In this case, for example, electric fields generated due to radio waves propagating through a region situated around the human body 1a and due to walking, act on the human body 1a to induce alternating current, and an alternating-current magnetic field is generated on the surface of the human body 1a. This magnetic field is captured by the energy harvester 100 as power.

### [Specific Application Example]

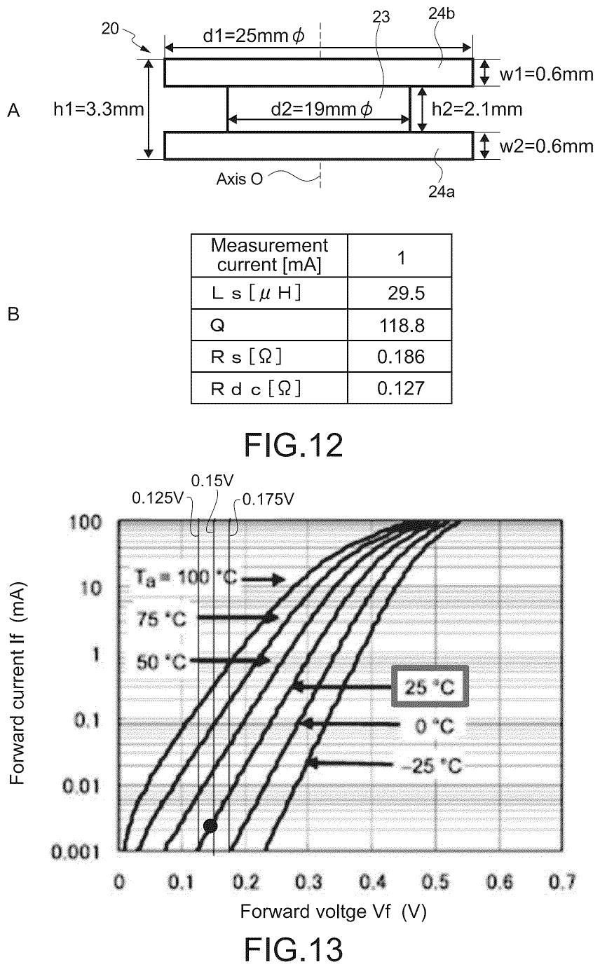

FIG. 12 illustrates examples of a specific configuration of and characteristics of the coil section. The coil section 10 illustrated in FIG. 12 was a thin coil that uses the drum-shaped core 20 including a flat surface that is circular as viewed from a direction of the coil axis. An Mn—Zn-based ferrite core was used as the core 20 in order to receive a low frequency.

As illustrated in A of FIG. 12, the entirety of the core 20 had a height (an outer width) hl of 3.3 mm, the first flange portion 24a had a thickness w1 of 0.6 mm, the second flange portion 24b had a thickness W2 of 0.6 mm, and the axial portion 23 around which the wire rod 21 was wound had a height (an inner width) of 2.1 mm. Further, the entirety of the core 20 had a diameter d1 (the first flange portion 24a and the second flange portion 24b each had a diameter) of φ25 mm, and the axial portion 23 had a diameter d2 of φ19 mm. A litz wire having a wire diameter of 0.65 mm was wound around the axial portion 23 of the core 20 using alpha winding to form the coil section 10. Further, the number of turns of the litz wire was three steps×six layers.

B of FIG. 12 illustrates the characteristics of the coil section 10 illustrated in A of FIG. 12. Here, the nonmagnetic body 12 was not provided, and measurement was performed on the coil section 10 alone. An LCR meter was used to perform the measurement, with a measurement frequency of 120 KHz and a measurement current of 1 mA.

The coil section 10 exhibited an inductance Ls of 29.5 pH and a quality factor of 118.8. Further, the coil section 10 exhibited an equivalent series resistance Rs of 0.186Ω and a direct-current resistance Rdc of 0.127Ω.

The inventors conducted experiments to attach the coil section 10 illustrated in FIG. 12 to the exterior of a refrigerator 1 and to harvest power using the rectifier circuit 14 illustrated in FIG. 8. In the experiments, a secondary battery that corresponds to the power storing element 16 was connected between the output terminals 45a and 45b of the rectifier circuit 14, and the secondary battery was directly charged through the backflow prevention diode 43. During charging, a voltage V1 between the output terminals 45a and 45b was 2.300 V. Here, an output voltage V2 of the rectifier circuit 14 before passage through the backflow prevention diode 43 (in this case, voltage between a detection point 46a situated on the side of the cathode of the Zener diode 42b and a detection point 46b situated on the side of the anode of the Zener diode 42b) was 2.444 V. Thus, a voltage drop due to the backflow prevention diode 43 was about 0.144 V.

FIG. 13 is a graph illustrating Vf-If characteristics of the backflow prevention diode. In FIG. 13, a relationship between a forward voltage Vf and a forward current If with respect to the backflow prevention diode 43 is given for each measurement temperature (100° C., 75° C., 50° C., 25° C., 0° C., and −25° C.). A horizontal axis of the graph represents the forward voltage Vf applied to the backflow prevention diode 43, and a vertical axis of the graph represents the forward current If flowing through the backflow prevention diode 43.

A line graph of the Vf-If characteristics at a room temperature of 25° C. is referred to. As described above, a voltage drop due to the backflow prevention diode 43 in the forward direction was 0.144 V. This shows that a current of about 2.5 μA (refer to a black circle in the graph illustrated in FIG. 13) was output from the backflow prevention diode 43 as the forward current If to be stored in the secondary battery.

Note that, in these experiments, the voltage between the output terminals 45a and 45b when the secondary battery was not connected between the output terminals 45a and 45b was about 4.5 V. It can be said that this voltage value corresponds to voltage sufficient to charge various secondary batteries.

It has turned out, from the result of the experiments described above, that energy of a magnetic field that is induced in the coil section 10 can be captured to be stored in a secondary battery.

In the energy harvester 100 according to the present embodiment, the coil section 10 is maintained on the surface of the target 1 including a metallic body or a human body, such that the axis O of the coil section 10 intersects the surface of the target 1, as described above. Further, output from the coil section 10 is rectified to be used as power. The core 20 of the coil section 10 is made of a magnetic material. Thus, magnetic flux generated around the target 1 can be collected. This makes it possible to efficiently capture energy of a magnetic field that is generated in the surrounding environment.

### Second Embodiment

An energy harvester of a second embodiment according to the present technology is described. In the following description, descriptions of a configuration and an operation that are similar to those of the energy harvester 100 described in the embodiment above are omitted or simplified.

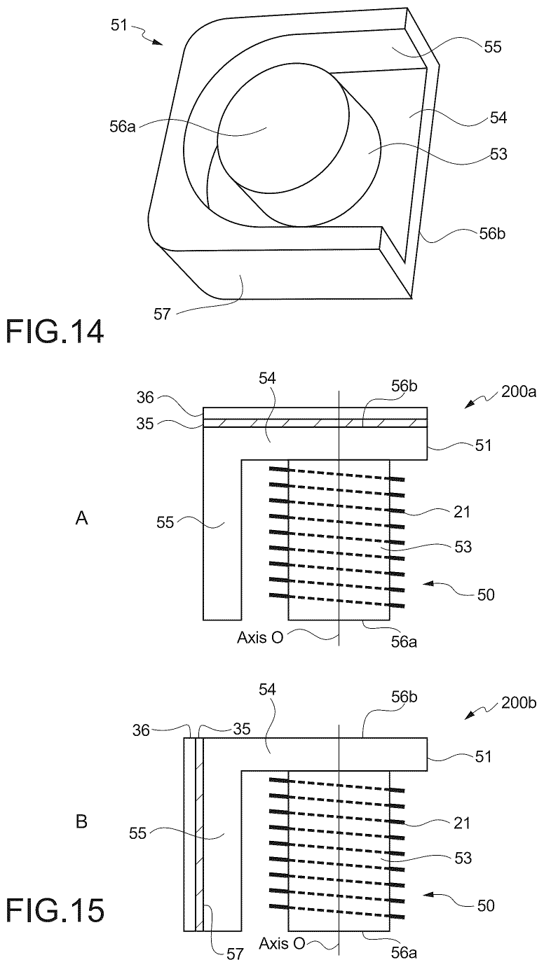

FIG. 14 is a perspective view of an example of a configuration of a core of a coil section according to the second embodiment. FIG. 15 schematically illustrates examples of configurations of energy harvesters that each include a core 51 illustrated in FIG. 14.

In the present embodiment, the core 51 of a coil section 50 is formed such that a magnetic material covers around an axial portion 53.

As illustrated in FIG. 14, the core 51 includes the axial portion 53, a flange portion 54, and a sidewall 55. The entirety of the core 51 is made of a magnetic material (typically, soft ferrite).

The axial portion 53 is a portion around which the wire rod 21 is wound, and is a solid member that is filled into a space inside of a loop formed by the wire rod 21. In the present embodiment, the axial portion 53 having a cylindrical shape is formed. Moreover, a shape of the axial portion 53 is not limited, and any columnar shape may be used.

The flange portion 54 is a portion that is provided at one of two ends of the axial portion 53 and protrudes further outward than the peripheral surface of the axial portion 53. In the present embodiment, the flange portion 54 including a square-shaped flat surface is formed, and the axial portion 53 is connected to the flange portion 54 such that a central axis of the axial portion 53 (the axis O of the coil section 50) passes through a center of the flange portion 54. Moreover, the shape of the flat surface of the flange portion 54 is not limited thereto.

The sidewall 55 is a portion that is connected to the flange portion 54 and spaced from the axial portion 53 to surround at least a portion of the axial portion 53. In other words, the sidewall 55 forms a wall that protrudes from a surface that is included in the flange portion 54 and connected to the axial portion 53, the wall being situated at a position distant from the axial portion 53 to surround the axial portion 53. In the present embodiment, the sidewall 55 is formed in the flange portion 54 including a square-shaped flat surface, where the sidewall 55 protruding from three out of four sides that form an outer edge of the flange portion 54. Note that spacing between the axial portion 53 and the sidewall 55 is set such that the wire rod 21 can be wound with at least a desired number of turns of the wire rod 21.

A and B of FIG. 15 are schematic cross-sectional views of respective energy harvesters 200a and 200b that are each formed using the core 51 illustrated in FIG. 14, where the energy harvesters 200a and 200b are each cut along the axis O of the coil section 50. Here, an example in which a circuit section 36 that is formed on a nonmagnetic body 35 is directly arranged on the core 51 of the coil section 50 is described. Without being limited thereto, the coil section 50 (the core 51) may be accommodated in a specified housing, and the nonmagnetic body 35 and the circuit section 36 may be arranged on the housing.

The coil section 50 (the core 51) of the energy harvester 200a and the coil section 50 (the core 51) of the energy harvester 200b have configurations similar to each other, but the nonmagnetic body 35 and the circuit section 36 of the energy harvester 200a are respectively arranged at positions different from positions at which the nonmagnetic body 35 and the circuit section 36 of the energy harvester 200b are arranged.

First, arrangement of the coil section 50 is described. The coil section 50 is arranged such that another of the two ends of the axial portion 53 (the end situated opposite to the end at which the flange portion 54 is provided) faces the target 1. In each of A and B of FIG. 15, a surface of the coil section 50 that is situated in a lower portion in the figure faces the target 1.

When a housing is not used, as illustrated in FIG. 15, the coil section 50 is maintained directly by, for example, a specified attachment mechanism that serves as a maintaining portion, such that the other of the two ends of the axial portion 53 faces the target 1. Further, when the coil section 50 is accommodated in a housing, the coil section 50 is maintained by the housing serving as a maintaining portion, such that the other of the two ends of the axial portion 53 faces the target 1.

In the present embodiment, a surface that is formed at the other of the two ends of the axial portion 53 is a first end surface 56a that faces the target 1, and a surface of the flange portion 54 that is situated opposite to a surface of the flange portion 54 that is connected to the axial portion 53 is a second end surface 56b, as described above. A portion of the axial portion 53 surrounded by the sidewall 55 is exposed on the side of the first end surface 56a, and this makes it easy to capture magnetic flux.

In general, magnetic flux easily passes through a magnetic material. Thus, the axial portion 53 is surrounded by the sidewall 55 and flange portion 54 being made of a magnetic material, and the first end surface 56a corresponding to the exposed portion of the axial portion 53 faces the target 1. Consequently, an effect of enclosing magnetic flux that is generated around the coil section 50 is expected to be provided. It can be said that this is a configuration in which magnetic flux coming from the target 1 is exclusively received on a front side (on the side of the first end surface 56a) on which energy is to be received.

This results in magnetic flux being concentrated onto the axial portion 53 around which the wire rod 21 is wound, and thus in being able to capture magnetic-field energy very efficiently.

Further, magnetic flux is less likely to leak out of the core 51. This results in reducing a degradation in quality factor that is caused due to metal of, for example, the circuit section 36. Further, the nonmagnetic body 35 is arranged, and this makes it possible to sufficiently reduce a degradation in quality factor. Furthermore, magnetic flux is less likely to leak into a region situated around the core 51. This makes it possible to increase a degree of freedom in the arrangement of the circuit section 36 relative to the core 51.

In A of FIG. 15, the nonmagnetic body 35 and the circuit section 36 are arranged in this order on the second end surface 56b being included in the flange portion 54 and situated opposite to the first end surface 56a. In other words, the nonmagnetic body 35 and the circuit section 36 are arranged to be orthogonal to the axis O of the coil section 50. The sidewall 55 is arranged, as described above, and this results in magnetic flux being less likely to leak. Consequently, the quality factor is not greatly degraded even when the circuit section 36 and the others are arranged on the axis O of the coil section 50.

In B of FIG. 15, the nonmagnetic body 35 and the circuit section 36 are arranged in this order on an outer surface 57 of the sidewall 55. In other words, the nonmagnetic body 35 and the circuit section 36 are arranged to be orthogonal to the axis O of the coil section 50. Here, the nonmagnetic body 35 and the circuit section 36 are provided on a portion of the outer surface 57 that corresponds to a middle portion of the U-shaped sidewall 55. However, the nonmagnetic body 35 and the circuit section 36 may be provided on another portion of the outer surface 57 that corresponds to another portion of the U-shaped sidewall 55 that is formed along one of two side portions other than the middle portion in the U shape. In this case, magnetic flux is less likely to leak due to the flange portion 54 and the sidewall 55. This makes it possible to sufficiently reduce a degradation in quality factor that is caused due to the circuit section 36.

Further, in B of FIG. 15, the contact surface brought into contact with the target 1 may be the other surface. In other words, the energy harvester 200b may be arranged such that the second end surface 56b of the flange portion 54 is brought into contact with the surface of the target 1. In this case, for example, magnetic flux can be collected from a large portion with which the flange portion 54 is brought into contact.

### Third Embodiment

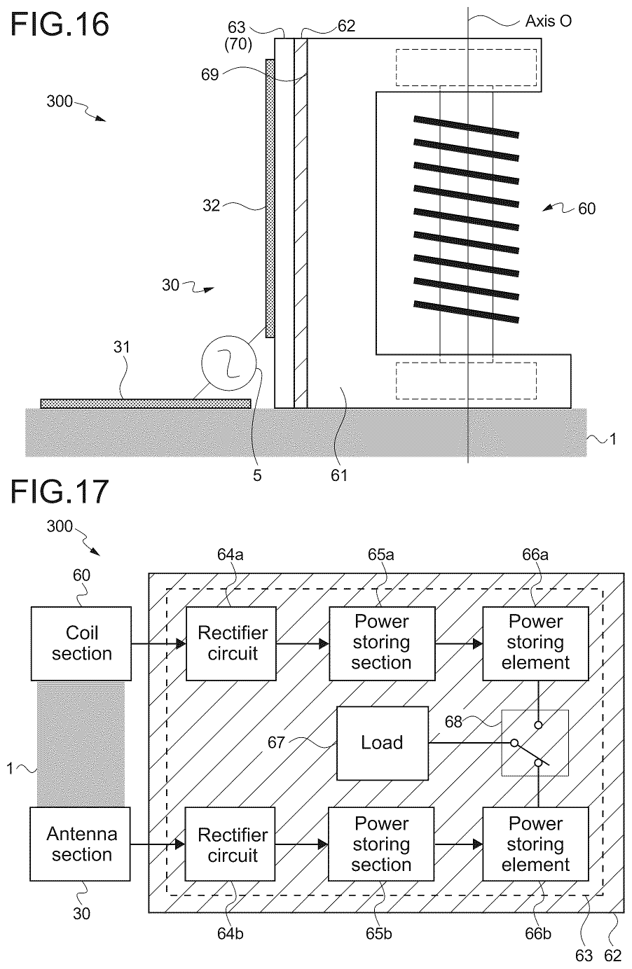

FIG. 16 schematically illustrates an example of a configuration of an energy harvester according to a third embodiment. FIG. 17 is a block diagram illustrating an example of a functional configuration of an energy harvester 300. In addition to a coil section 60 used to capture magnetic-field energy, the energy harvester 300 includes an antenna section 30 used to capture energy of an electric field generated in the surrounding environment.

The energy harvester 300 includes the coil section 60, a housing 61, a nonmagnetic body 62, a circuit section 63, and the antenna section 30. The coil section 60, the housing 61, and the nonmagnetic body 62 are respectively formed similarly to, for example, the coil section 10, the housing 11, and the nonmagnetic body 12 of the energy harvester 100 illustrated in FIG. 1. Thus, the energy harvester 300 illustrated in FIG. 16 is an apparatus having a changed circuit configuration obtained by adding the antenna section 30 to the energy harvester 100 illustrated in FIG. 1.

The antenna section 30 serves as a reception antenna used to receive power through the target 1 including a metallic body or a human body. For example, the antenna section 30 receives, as power, energy of an electric field, such as radio waves and a quasi-electrostatic field, that is present in a surrounding space that surrounds the target 1.

Thus, the energy harvester 300 is an apparatus that can draw magnetic-field energy from the target 1 such as a metallic body or a human body using the coil section 60, and can further draw electric-field energy from the target 1 such as a metallic body or a human body using the antenna section 30. Consequently, power can be harvested using both the coil section 60 and the antenna section 30. This makes it possible to harvest power efficiently.

First, the circuit section 63 of the energy harvester 300 is described with reference to FIG. 17.

In the present embodiment, the circuit section 63 includes a circuit for the coil section 60 and a circuit for the antenna section 30. The circuit for the coil section 60 includes a rectifier circuit 64a, a power storing section 65a, and a power storing element 66a. The circuit for the antenna section 30 includes a rectifier circuit 64b, a power storing section 65b, and a power storing element 66b. Further, the circuit section 63 further includes a switch section 68 and a load 67.

The circuit for the coil section 60 charges, as power, magnetic-field energy captured by the coil section 60.

The rectifier circuit 64a rectifies output from the coil section 60. In the present embodiment, the coil section 60 and the rectifier circuit 64a form a power receiver that receives, as power, energy of a magnetic field generated around the target 1.

The power storing section 65a charges, to the power storing element 66a, the power output from the rectifier circuit 64a.

The power storing element 66a is an element that stores therein the power received by the coil section 60.

In the energy harvester 300, a charging apparatus for the coil section 60 is formed that charges output from the coil section 60 to the power storing element 66a through the rectifier circuit 64a and the power storing section 65a, as described above.

The circuit for the antenna section 30 charges, as power, electric-field energy captured by the antenna section 30.

The rectifier circuit 64b rectifies output from the antenna section 30. In the present embodiment, the antenna section 30 and the rectifier circuit 64b form a power receiver that receives, as power, energy of an electric field generated around the target 1.

The power storing section 65b charges, to the power storing element 66b, the power output from the rectifier circuit 64b.

The power storing element 66b is an element that stores therein the power received by the antenna section 30.

In the energy harvester 300, a charging apparatus for the antenna section 30 is formed that charges output from the antenna section 30 to the power storing element 66b through the rectifier circuit 64b and the power storing section 65b, as described above.

The rectifier circuits 64a and 64b are each formed similarly to, for example, the rectifier circuit 14 described with reference to FIG. 6. Further, the power storing sections 65a and 65b are each formed similarly to, for example, the power storing section 15 of FIG. 1, and the power storing elements 66a and 66b are each formed similarly to, for example, the power storing element 16 of FIG. 1. Moreover, circuits depending on characteristics of the coil section 60 and characteristics of the antenna section 30 may be used.

In the present embodiment, the rectifier circuit 64a corresponds to a coil rectifier circuit, and the rectifier circuit 64b corresponds to an antenna rectifier circuit. Further, the rectifier circuit 64a and the rectifier circuit 64b form a rectifier.

The switch section 68 is a circuit that performs switching on the power storing element 66a and the power storing element 66b to connect one of the power storing element 66a and the power storing element 66b to the load 67. The load 67 is a circuit or element such as a sensor that is driven by power supplied by the power storing elements 66a and 66b.

For example, the switch section 68 performs control to detect charging rates of the power storing element 66a and the power storing element 66b, and to connect, to the load 67, one of the power storing elements 66a and 66b that exhibits a higher charging rate. Alternatively, when the charging rate of the power storing element connected to the load 67 is less than a specified threshold, switching to connect the other power storing element to the load 67 is performed. Such a control may be performed. Moreover, the method for performing switching on the power storing element 66a and the power storing element 66b is not limited.

In the energy harvester 300, two kinds of power harvested by both antennas, that is, the coil section 60 and the antenna section 30 are respectively stored in the two power storing elements 66a and 66b, as described above. Further, the switch section 68 performs switching to supply the stored power to the load 67.

Energy harvested by the coil section 60 is magnetic-field energy, and energy harvested by the antenna section 30 is electric-field energy. Thus, it is conceivable that, for example, current generated in the coil section 60 and current generated in the antenna section 30 could be 90 degrees out of phase with each other. The configuration described above also makes it possible to store power with no interference in such a case. This results in a reduction in losses caused when energy is converted into power, and thus in being able to efficiently capture magnetic-field energy and electric-field energy.

Next, the antenna section 30 is specifically described.

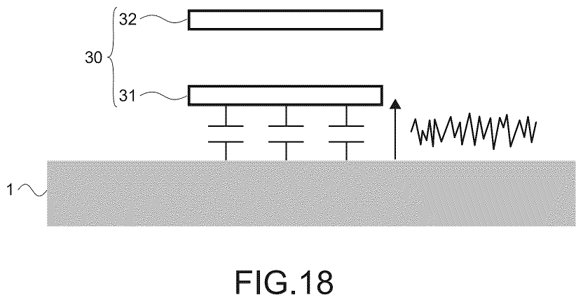

FIG. 18 is a schematic diagram used to describe an operation of the antenna section 30.

The antenna section 30 includes a first antenna conductor 31 and a second antenna conductor 32. The first antenna conductor 31 is a conductor that is electrically coupled to the target 1 including a metallic body or a human body. The second antenna conductor 32 is a conductor that is different from the first antenna conductor 31 and is not connected to the target 1.

FIG. 18 schematically illustrates the first antenna conductor 31 being electrically coupled to the surface of the target 1. The first antenna conductor 31 may be in direct contact with the surface of the target 1, or may be capacitively coupled to the surface of the target 1.

The antenna section 30 is a dipole-structure antenna that includes the first antenna conductor 31 and the second antenna conductor 32. In the present disclosure, the dipole-structure antenna is an antenna having a structure in which an electric field is transmitted and received using two antenna elements.

The target 1 to which the first antenna conductor 31 is coupled is a metallic body or human body that is insulated from the earth GND (that is above the earth GND). Thus, the target 1 serves as one of the antenna elements through the first antenna conductor 31. From another point of view, it can also be said that the first antenna conductor 31 is an electrode that causes the target 1 to serve as an antenna element.

Note that the second antenna conductor 32 is a conductor that is different from the first antenna conductor 31 and is not connected to the target 1. Thus, the second antenna conductor 32 serves as another antenna element.

For example, regardless of the frequency of an electric field, a conductor on which the electric field acts is sure to have a portion in which a voltage is high and a portion in which the voltage is low. Thus, when an electric field acts on two antenna elements (the first antenna conductor 31 and the second antenna conductor 32), current is sure to flow through the two antenna elements. Current that flows through each antenna element is not necessarily a largest current that can be drawn from an electric field. At any rate, current (energy of an electric field) can be drawn from each antenna element.

The antenna section 30 receives energy of an electric field using these effects.

In general, there are various kinds of electric-field energy in an environment in which people are active. These kinds of electric-field energy can be classified into low-frequency components and high-frequency components.

For example, leakage electric field (50 Hz/60 Hz) leaked from a household alternating-current power supply, noise present near a personal computer, and voltage caused when a person is walking each correspond to electric-field energy of a low-frequency component, and are referred to as quasi-electrostatic fields (near fields). On the other hand, for example, radio broadcasting (AM/FM), television broadcasting, and communication radio waves of, for example, cellular phones each correspond to electric-field energy of a high-frequency component, and are referred to as radio waves (far fields).

The antenna section 30 can capture two kinds of electric-field energy that are a quasi-electrostatic field such as noise corresponding to leakage current, and radio waves such as airwaves, using the target 1 as an antenna element. Further, the antenna section 30 receives power obtained by combining energy of a quasi-electrostatic field and energy of radio waves. FIG. 18 schematically illustrates a waveform of power received through the target 1. The waveform of power is a waveform including a wide range of frequency components. The target 1 is caused to serve as an antenna element, as described above, and this makes it possible to capture electric-field energy over a very wide range of frequencies.

A configuration of the antenna section 30 included in the energy harvester 300 is described below with reference to FIG. 16.

FIG. 16 schematically illustrates hatched regions that respectively represent the first antenna conductor 31 electrically coupled to the target 1, and the second antenna conductor 32 provided separately from the first antenna conductor 31. As described above, alternating current depending on an electric field present around the target 1 flows between the first antenna conductor 31 and the second antenna conductor 32. It can also be said that a virtual alternating-current power supply 5 is connected between the first antenna conductor 31 and the second antenna conductor 32, as illustrated in FIG. 16.

In the present embodiment, on the surface of the target 1, the first antenna conductor 31 is arranged further outward than a region, on the surface of the target 1, that the coil section 60 faces. In other words, the first antenna conductor 31 is arranged not to be situated between the coil section 60 and the target 1.

In the example illustrated in FIG. 16, the nonmagnetic body 62 is arranged at a specified distance from the coil section 60 in parallel with the axis O of the coil section 60. The first antenna conductor 31 is arranged along a portion of the surface of the target 1 that is situated across the nonmagnetic body 62 from another portion of the surface of the target 1 that is situated on the side of the coil section 60. The first antenna conductor 31 may be, for example, a different member and may be connected to the body using wiring, or may be fixed to, for example, the housing 61 using a maintaining device such as a hinge.

As described above, the first antenna conductor 31 is arranged at a position, on the target 1, that is distant from the coil section 60 such that the first antenna conductor 31 is not situated in a region, on the target 1, that the coil section 60 faces. This makes it possible to sufficiently reduce a degradation in, for example, the quality factor of the coil section 60. In particular, the provision of the nonmagnetic body 62 between the coil section 60 and the first antenna conductor 31 makes it possible to sufficiently reduce an impact that the first antenna conductor 31 has on the coil section 60. Further, the coil section 60 can be arranged closely to the surface of the target 1 since the first antenna conductor 31 does not interfere with the coil section 60 (the housing 61). This makes it possible to efficiently capture magnetic-field energy.

A plate member including a conductor made of, for example, gold, silver, aluminum, copper, iron, nickel, or an alloy is used for the first antenna conductor 31. Further, the first antenna conductor 31 may have, for example, a linear shape, a pin shape, a hemispheric shape, or a concave-convex shape according to the shape of the surface of the target 1. This results in improving adhesion between the first antenna conductor 31 and the target 1, and thus in being able to efficiently capture power. Further, a contact surface of the first antenna conductor 31 that is brought into contact with the target 1 may be coated with resin. This makes it possible to prevent the first antenna conductor 31 from, for example, corroding.

Further, a conductive resin or rubber containing, for example, carbon or metal may be used for the first antenna conductor 31. The use of a conductive resin makes it possible to easily form, for example, electrodes of various shapes. Further, the use of a conductive rubber makes it possible to form, for example, an elastically deformable electrode or an electrode with a high degree of adhesiveness.

Moreover, a material of the first antenna conductor 31 is not limited. One of the materials described above may be used alone or the materials may be used in combination to form an electrode.

Further, in the present embodiment, the second antenna conductor 32 is arranged parallel to the axis O of the coil section 60. In other words, the second antenna conductor 32 extends in parallel with the axis O of the coil section 60.

In the example illustrated in FIG. 16, the housing 61 accommodating therein the coil section 60 includes a lateral surface 69 that is parallel to the axis O of the coil section 60. The nonmagnetic body 62 and a circuit board 70 that is included in the circuit section 63 are arranged along the lateral surface 69.

The second antenna conductor 32 is formed on the circuit board 70. The second antenna conductor 32 may be formed on the circuit board 70 as a different element, or a GND of a circuit included in the circuit board 70 may be used as the second antenna conductor 32. This makes it possible to easily obtain the second antenna conductor 32 parallel to the axis O of the coil section 60.

As described above, the arrangement of the second antenna conductor 32 in parallel with the axis O of the coil section 60 results in arranging a conductor in parallel with magnetic flux that passes through the coil section 60. It can be said that this is arrangement for reducing an impact that the second antenna conductor 32 has on the coil section 60. In particular, the nonmagnetic body 62 is arranged between the circuit board 70 on which the second antenna conductor 32 is provided, and the coil section 60. This makes it possible to sufficiently reduce an impact on the coil section 60. This results in being able to capture electric-field energy without reducing the efficiency in capturing magnetic-field energy.

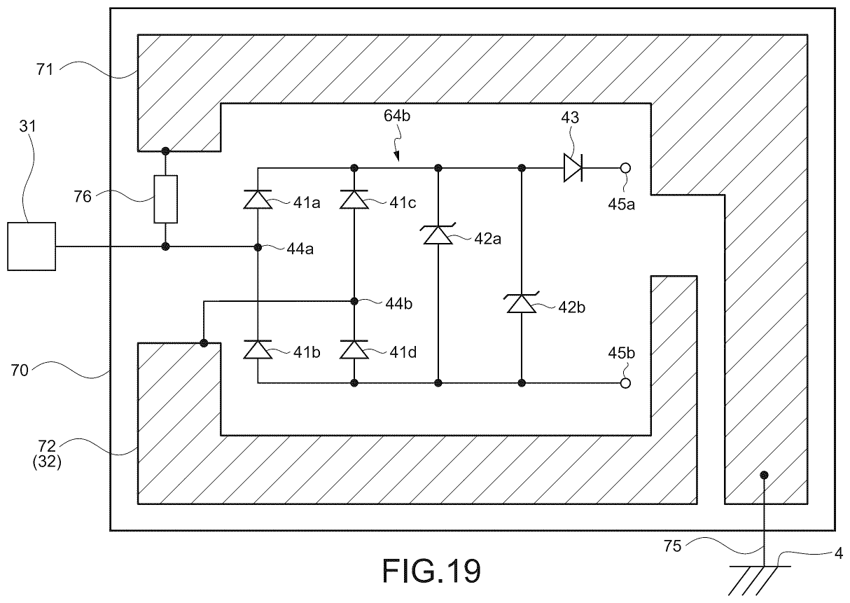

FIG. 19 schematically illustrates an example of a configuration of the second antenna conductor 32 formed on the circuit board 70. The circuit board 70 includes a board ground 71 and a conductor pattern 72 that is different from the board ground 71. The board ground 71 is a pattern that serves as a ground of the circuit section 63. The conductor pattern 72 is a pattern that serves as the second antenna conductor 32, and serves as an antenna element that is capacitively coupled to the earth ground 4.

The board ground 71 and the conductor pattern 72 are formed not to overlap the circuit section 63. In FIG. 19, a circuit diagram of the rectifier circuit 64b for the antenna section 30 in the circuit section 63 is depicted in a region formed by being surrounded by the board ground 71 and the conductor pattern 72. The rectifier circuit 64b has a configuration similar to the configuration of the rectifier circuit 14 described with reference to FIG. 6. Note that, in addition to the rectifier circuit 64b, another circuit or element (such as the rectifier circuit 64a for the coil section 60) that is included in the circuit section 63 illustrated in FIG. 17 may be provided.

The first antenna conductor 31 is connected to the connection point 44a of the rectifier circuit 64b. Further, the conductor pattern 72 serving as the second antenna conductor 32 is connected to the connection point 44b of the rectifier circuit 64b. This results in the rectifier circuit 64b being supplied with alternating-current power depending on an electric field generated around the target 1.

Further, in the example illustrated in FIG. 19, the board ground 71 is grounded to the earth ground 4 through an insulated sheathed cable 75. This makes it possible to provide a stable ground potential to the circuit section 63. Note that, for example, a varistor 76 is inserted as an electrostatic protection component between the board ground 71 and the first antenna conductor 31 (the connection point 44a of the rectifier circuit 64b). Note that the varistor 76 may be inserted between the output terminal 45a of the rectifier circuit 64b and the board ground 71. Any other structural element may be used as the second antenna conductor 32.

For example, the conductor pattern 72 illustrated in FIG. 19 may be grounded to the earth ground through an insulated sheathed cable. In this case, an electrostatic protection component (such as a varistor) is inserted between the conductor pattern 72 and the first antenna conductor 31 (the connection point 44a of the rectifier circuit 64b). The above-described grounding of the conductor pattern 72 makes it possible to improve the efficiency in capturing power, compared to, for example, when the conductor pattern 72 is capacitively coupled to the earth ground 4.

Further, the board ground 71 may be used as the second antenna conductor 32. In this case, the board ground 71 is connected to the connection point 44b of the rectifier circuit 64b. Further, there is no need to provide the conductor pattern 72 since the board ground 71 serves as the second antenna conductor 32.

Furthermore, the board ground 71 serving as the second antenna conductor 32 may be grounded to the earth ground 4. In this case, for example, an inductor may be inserted into between the board ground 71 and the earth ground 4 since, in some cases, there is a need for a component exhibiting a high impedance in a frequency band to be used. Further, an electrostatic protection component (such as a varistor) is inserted between the board ground 71 and the first antenna conductor 31 (the connection point 44a of the rectifier circuit 64b). Further, the board ground 71 may be capacitively coupled to the earth ground 4 without being grounded to the earth ground 4.

Further, there is no need to provide the second antenna conductor 32 on the circuit board 70. For example, a portion of the housing 61 accommodating therein the coil section 60 that is not brought into contact with the target 1 is formed using a conductor made of, for example, metal. Such a conductor portion of the housing 61 may be used as the second antenna conductor 32. Furthermore, the conductor portion of the housing 61 and the conductor pattern 72 may be connected to each other through a cable, and the connected conductor portion of the housing 61 and conductor pattern 72 may be used as the second antenna conductor 32, or the conductor portion of the housing 61 and the board ground 71 may be connected to each other through a cable, and the connected conductor portion of the housing 61 and board ground 71 may be used as the second antenna conductor 32.

Further, the nonmagnetic body 62 provided to the housing 61 may be used as the second antenna conductor 32. In this case, for example, an insulated sheathed cable is connected to the nonmagnetic body 62 made of aluminum or copper, using, for example, soldering, brazing, swaging, or fastening with a screw. This cable is connected to the connection point 44b of the rectifier circuit 64b formed on the circuit board 70. This makes it possible to provide the second antenna conductor 32 without increasing the number of components.

### Fourth Embodiment

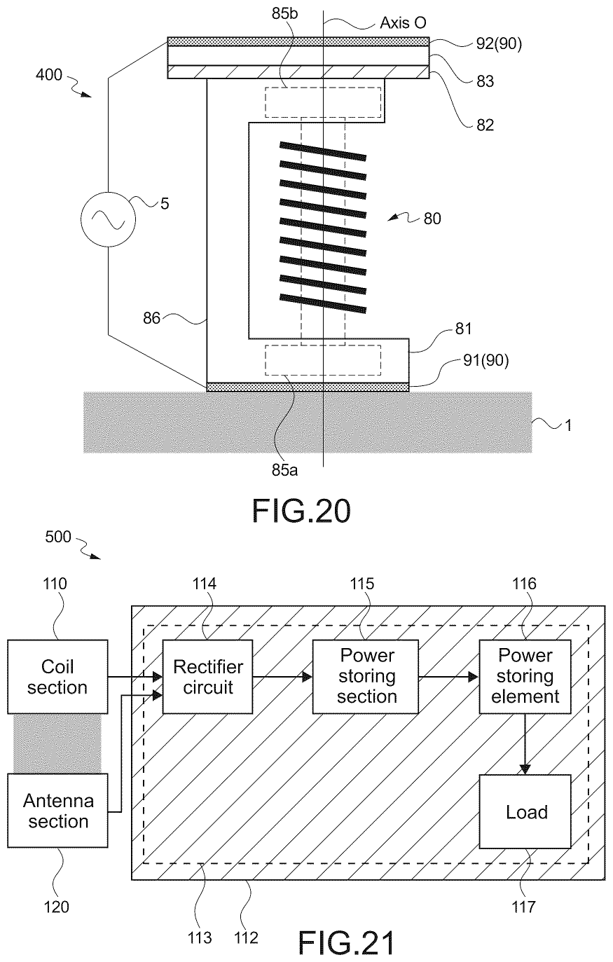

FIG. 20 schematically illustrates an example of a configuration of an energy harvester according to a fourth embodiment. An energy harvester 400 has a configuration in which an antenna section 90 that is an electric-field antenna, and a coil section 80 that is a magnetic-field antenna overlap. This configuration makes it possible to make the entirety of the energy harvester 400 smaller in size.

The energy harvester 400 includes the coil section 80, a housing 81, a nonmagnetic body 82, a circuit section 83, and the antenna section 90. The coil section 80 and the housing 81 respectively have configurations respectively similar to, for example, the configurations of the coil section 10 and the housing 11 of the energy harvester 100 illustrated in FIG. 1. Further, the circuit section 83 has a functional configuration similar to, for example, the functional configuration of the circuit section 63 described with reference to FIG. 17.

The nonmagnetic body 82 and the circuit section 83 are provided on a side of the coil section 80 that is situated opposite to a side of the coil section 80 that faces the target 1.

As illustrated in FIG. 20, a first end surface 85a that faces the target 1 and a second end surface 85b that is situated opposite to the first end surface 85a are formed in the coil section 80. The nonmagnetic body 82 and the circuit section 83 are arranged on the side of the second end surface 85b from between the two end surfaces to be orthogonal to the axis O of the coil section 80. More specifically, the nonmagnetic body 82 and the circuit section 83 are arranged by being stacked in this order on a surface of the housing 81 that is situated on the side of the second end surface 85a of the coil section 80.

Further, in the energy harvester 400, a first antenna conductor 91 and a second antenna conductor 92 that are included in the antenna section 90 are arranged such that the coil section 80 is situated between the first antenna conductor 91 and the second antenna conductor 92. Specifically, the first antenna conductor 91 is arranged to face the first end surface 85a of the coil section 80. Further, the second antenna conductor 92 is arranged to face the second end surface 85b of the coil section 80.

As illustrated in FIG. 20, the first antenna conductor 91 is connected to a surface of the housing 81 that is situated on the side of the first end surface 85a of the coil section 80. Thus, it can also be said that the housing 81 and the coil section 80 are formed on the first antenna conductor 91 used in contact with the target 1 such as a metallic body or a human body. This makes it possible to make the apparatus smaller in size, compared to, for example, a configuration in which the first antenna conductor 91 is arranged not to be situated between the coil section 80 and the target 1 (refer to FIG. 16).

Further, the second antenna conductor 92 is arranged along the surface being included in the housing 81 and situated on the side of the second end surface 85b of the coil section 80. In the present embodiment, the second antenna conductor 92 is formed on the circuit section 83 provided on the side of the second end surface 85b to be orthogonal to the axis O of the coil section 80. In this case, for example, the conductor pattern described with reference to FIG. 19 is used as the second antenna conductor 92. The first antenna conductor 91 and the second antenna conductor 92 are arranged to be situated across the coil section 80 from each other, as described above, and this makes it possible to increase, for example, an amount of current induced in each conductor.

Further, the nonmagnetic body 82, the circuit section 83, and the second antenna conductor 92 are arranged on the upper surface of the housing 81. This makes it possible to make the apparatus smaller in size, and to sufficiently reduce an impact that, for example, the circuit section 83 has on the coil section 80.

Note that there is no need to provide the second antenna conductor 92 to the circuit section 83. For example, the second antenna conductor 92 may be provided using, for example, a conductor plate that is separate from the circuit section 83 or a portion of the housing 81. Alternatively, the second antenna conductor 92 may be provided using the nonmagnetic body 82.

Further, the nonmagnetic body 82, the circuit section 83, and the second antenna conductor 92 may be arranged parallel to the axis O of the coil section 80. For example, the nonmagnetic body 82, the circuit section 83, and the second antenna conductor 92 may be arranged on a lateral surface 86 of the housing 81.

### Fifth Embodiment

FIG. 21 is a block diagram illustrating an example of a functional configuration of an energy harvester according to a fifth embodiment. An energy harvester 500 includes a coil section 110, a housing (not illustrated), a nonmagnetic body 112, a circuit section 113, and an antenna section 120. A shared circuit used to charge power output from the coil section 110 and power output from the antenna section 120, is formed in the circuit section 113 from among those structural elements.

As illustrated in FIG. 21, the circuit section 113 includes a rectifier circuit 114, a power storing section 115, a power storing element 116, and a load 117.

The rectifier circuit 114 is connected to both the coil section 110 and the antenna section 120, and rectifies output from the coil section 110 and output from the antenna section 120. In the present embodiment, the rectifier circuit 114 corresponds to a shared rectifier circuit. The rectifier circuit 114 has a configuration similar to, for example, the configuration of the rectifier circuit 14 described with reference to FIG. 8.

The output from the coil section 110 and the output from the antenna section 120 that are rectified by the rectifier circuit 114 are stored in the power storing element 116 through the power storing section 115 and supplied to the load 117 situated on an output side of the power storing element 116 as appropriate.

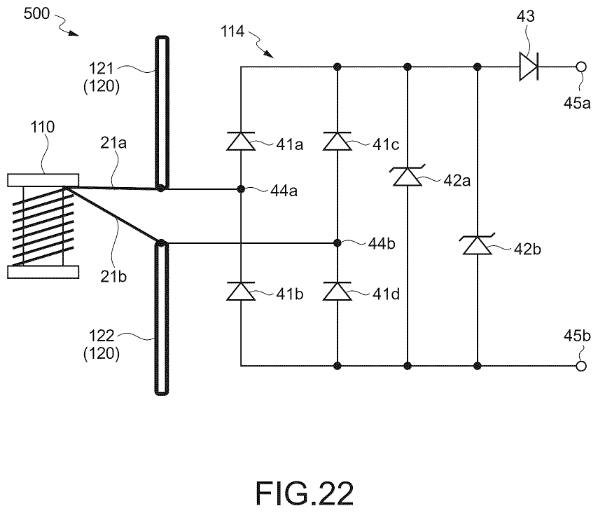

FIG. 22 is a circuit diagram illustrating an example of how to connect the coil section 110 and the antenna section 120 to the rectifier circuit 114. A first coil terminal 21a of the coil section 110 is connected to the connection point 44a of the rectifier circuit 114 through a first antenna conductor 121 of the antenna section 120. Further, a second coil terminal 21b of the coil section 110 is connected to the connection point 44b of the rectifier circuit 114 through a second antenna conductor 122 of the antenna section 120.

This makes it possible to supply the rectifier circuit 114 with both output from the coil section 110 and output from the antenna section 120.

For example, in the configuration described with reference to FIG. 17, output from the coil section 60 serving as a magnetic-field antenna, and output from the antenna section 30 serving as an electric-field antenna are respectively charged to the power storing elements such as batteries, and switching is performed to use one of the output from the coil section 60 and the output from the antenna section 30. This is a configuration provided considering that a magnetic field and an electric field are 90 degrees out of phase with each other. In this case, there is a need to provide a dedicated circuit for each antenna.

On the other hand, in the configuration described with reference to FIGS. 21 and 22, output from the coil section 110 and output from the antenna section 120 can be stored using a shared circuit.

It is conceivable that various frequency components could be included in a magnetic field and an electric field that are generated around the target 1. Thus, magnetic-field energy and electric-field energy of various frequencies may be received depending on, for example, an environment in which the energy harvester 500 is used. Further, there is a need for a certain period of time from energy capturing to power supply. For example, the time taken to supply power may differ depending on frequency or antenna. For these reasons, power output from the coil section 110, and power output from the antenna section 120 are not necessarily 90 degrees out of phase with each other. Thus, output from the coil section 110 and output from the antenna section 120 may be used by the coil section 110 and the antenna section 120 being connected in series or in parallel to each other, as in the present embodiment.

This results in there being no need to provide a dedicated circuit for each antenna, and thus in being able to reduce, for example, costs for the apparatus.

### Other Embodiments

The present technology is not limited to the embodiments described above, and can achieve various other embodiments.

In the embodiments described above, the core of the coil section is formed primarily using a single magnetic material (soft ferrite). Without being limited thereto, at least two magnetic materials may be used in combination to form a core. For example, an amorphous alloy that exhibits a high magnetic permeability may be applied to the two flange portions in the drum-shaped (H-shaped) core. Examples of the amorphous alloy include an amorphous alloy based on cobalt (Co) such as an Mg—Zn-based alloy. The use of an amorphous alloy results in increasing the strength. This makes it possible to make the flange portions thinner, and thus to make the entirety of a core smaller in size.

Of course, the entirety of a core may be made of an amorphous alloy.

Further, for example, a T-shaped core that includes an axial portion provided with only a flange portion on one of two sides of the axial portion, or an I-shaped core formed only using an axial portion may be used in addition to the H-shaped core illustrated in FIG. 5 and the sidewall-provided core illustrated in FIG. 14.

Further, there is no need to arrange a coil section such that an axis of the coil section is orthogonal to a surface of a target. For example, the axis of the coil section may be inclined with respect to the surface of the target. In this case, magnetic flux that extends from the surface of the target can also be caught to be captured as power. Further, the coil section may be arranged to be in a pose that makes it possible to efficiently collect magnetic flux, according to a spatial distribution of current in the target (such as a three-dimensional form of the exterior).

Furthermore, a housing or the like does not necessarily have to be provided if the pose of the coil section is maintained. Moreover, the coil section does not necessarily have to be attached on the surface of the target. For example, a maintaining mechanism such as a clamp that is provided outside of the target and maintains the coil section, may be used. The coil section is arranged in contact with, or closely to the target such as home appliances using such an external maintaining mechanism, and this makes it possible to capture power.

There is no need to provide the circuit section to the coil section or on the housing of the coil section, and the circuit section and the coil section may be formed separately. Further, a plurality of coil sections may be connected to a single circuit section. Alternatively, a reception unit or the like obtained by integrating the coil section used to capture magnetic-field energy and an antenna section used to capture electric-field energy, may be formed. In this case, the reception unit may be connected to the circuit section using specified wiring. Further, a plurality of reception units may be connected to a single circuit section.

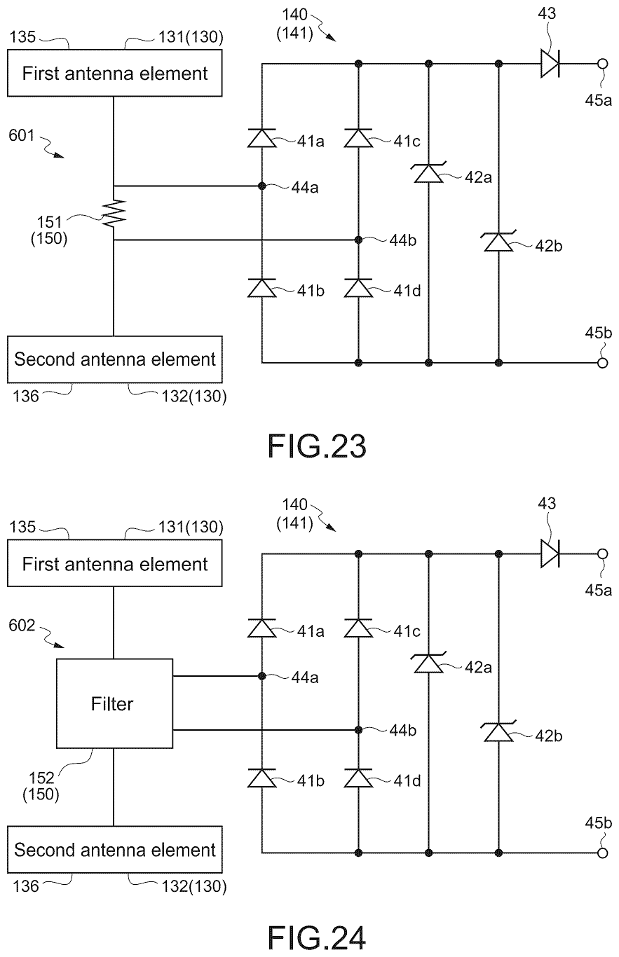

FIG. 23 is a circuit diagram illustrating an example of a configuration of an energy harvester that includes an isolation section. An energy harvester 601 illustrated in FIG. 23 is included inside of an apparatus, and harvests, as power, energy of an electric field generated in the apparatus. The energy harvester 601 includes an antenna section 130, a circuit section 140, and an isolation section 150.

Further, an illustration of a coil section used to capture magnetic-field energy is omitted below. Actually, the energy harvester 601 includes the coil section together with the antenna section 130. Furthermore, as described with reference to, for example, FIG. 17, a circuit used to charge power from the antenna section 130 and a circuit used to charge power from the coil section may be provided independently of each other. Moreover, as described with reference to, for example, FIGS. 21 and 22, a shared circuit used to charge power from the antenna section 130 and power from the coil section may be provided.

Note that a configuration described below may be applied to an energy harvester that only includes the antenna section 130 serving as an electric-field antenna, without including the coil section serving as a magnetic-field antenna.

The antenna section 130 includes two antenna elements (a first antenna element 131 and a second antenna element 132) used to capture electric-field energy.

Examples of the apparatus including the energy harvester 601 include conductors such as GNDs for various boards and metallic cases. The conductors are used as the first antenna element 131 and the second antenna element 132. This results in there being no need to newly add a conductor serving as an antenna element. This makes it possible to easily include the energy harvester 601 in various apparatuses. Note that the conductors used as the first antenna element 131 and the second antenna element 132 will be described later.

The circuit section 140 is a circuit that, for example, charges a power storing element (not illustrated) using power output from the antenna section 130. FIG. 23 illustrates a rectifier circuit 141 of the circuit section 140 that rectifies output from the antenna section 130. The rectifier circuit 141 has a configuration similar to, for example, the configuration of the rectifier circuit 14 described with reference to FIG. 8. The first antenna element 131 is connected to the connection point 44a of the rectifier circuit 141, and the second antenna element 132 is connected to the connection point 44b of the rectifier circuit 141.

Further, for example, a power storing section and a power storing element are provided on an output side of the rectifier circuit 141 in the circuit section 140. Note that a configuration of, for example, the rectifier circuit 141 included in the circuit section 140 is not limited.

The isolation section 150 is provided between the first antenna element 131 and the second antenna element 132, and isolates the first antenna element 131 from the second antenna element 132 in order not to leak electric-field energy. Specifically, the isolation section 150 prevents an alternating-current component including electric-field energy from easily flowing between the first antenna element 131 and the second antenna element 132, that is, reduces passage of the alternating-current component.

In the example illustrated in FIG. 23, an isolation resistance 151 is provided as the isolation section 150. The isolation resistance 151 is an element such as a winding resistance for which a specified direct-current resistance value is set. The provision of the isolation resistance 151 results in preventing current from easily flowing between the first antenna element 131 and the second antenna element 132, and thus in reducing passage of an alternating-current component. Further, the first antenna element 131 and the second antenna element 132 each get closer to a state of being electrically above the earth ground as a value of direct-current resistance of the isolation resistance 151 becomes larger. This results in preventing an alternating-current component from less easily flowing.

For example, the energy harvester 601 is included in an apparatus that is not grounded to the earth ground. The apparatus that is not grounded to the earth ground is, for example, an apparatus that is connected to an AC power supply but does not have to be grounded. Examples of such an apparatus include television, hard disk recorder, game device, and stereo component. Further, for example, drones and automobiles operate in a state of exhibiting a constant resistance between the earth ground and them. It can be said that these apparatuses are apparatuses used in a state of not being grounded to the earth ground, that is, in a state of being electrically above the earth ground.

For example, in the above-described apparatus not being grounded to the earth ground, a GND of a power supply board that includes, for example, a converter circuit and an inverter circuit that generate a large amount of power (hereinafter referred to as a power supply GND 135) is isolated from a conductor portion such as a metallic portion that is provided to the apparatus and other than the power supply GND 135 (hereinafter referred to as another conductor 136). This makes it possible to efficiently harvest power. In other words, the power supply GND 135 and the other conductor 136 are respectively used as antenna elements and the respective antenna elements are isolated from each other. This makes it possible to efficiently capture energy of an electric field generated in, for example, the converter circuit and the inverter circuit.

Specifically, the power supply GND 135 of an apparatus that includes the energy harvester 601 is used as the first antenna element 131.

Further, in the apparatus including the energy harvester 601, the other conductor 136 being a conductor portion other than the power supply GND 135 is used as the second antenna element 132. Examples of the other conductor 136 include a heat-dissipation plate and a metallic case that are included in the apparatus. Without being limited thereto, for example, any conductor that is provided separately from the power supply GND 135 may be used as the second antenna element 132.

The power supply GND 135 serving as the first antenna element 131 is isolated from the other conductor 136 serving as the second antenna element 132 by the isolation resistance 151 used as the isolation section 150.

Note that the power supply GND 135 serving as the first antenna element 131 is a conductor that is above the earth ground, since the power supply GND 135 is not grounded to the earth ground. On the other hand, the other conductor 136 serving as the second antenna element 132 does not necessarily have to be grounded to the earth ground, or may be grounded to the earth ground. In other words, the power supply GND 135 and the other conductor 136 respectively serve as antenna elements isolated from each other regardless of whether the other conductor 136 is grounded to the earth ground, since the power supply GND 135 is isolated from the other conductor 136 by the isolation resistance 151 and the power supply GND 135 is above the earth ground.

When, for example, the power supply GND 135 is not grounded at a timing at which the apparatus including the energy harvester 601 is connected to an AC power supply, the other conductor 136 such as a metallic case is connected in some cases to the earth ground through, for example, a cale connected to the apparatus. In such a case, the provision of the isolation resistance 151 also makes it possible to harvest electric-field energy through the power supply GND 135 and the other conductor 136.

As described above, the energy harvester 601 can be applied to an apparatus of which at least the power supply GND 135 is not grounded to the earth ground.

The provision of the isolation resistance 151 results in preventing an alternating-current component from easily flowing between the power supply GND 135 serving as the first antenna element 131 and the other conductor 136 serving as the second antenna element 132. Thus, the power supply GND 135 and the other conductor 136 serve as a dipole-structure antenna. Consequently, an alternating-current component depending on an electric field generated in, for example, an inverter circuit provided to a power supply board, is induced between the power supply GND 135 and the other conductor 136, and power of the alternating-current component can be harvested.

The inventors conducted experiments to measure power output from the antenna section 130 (the first antenna element 131 and the second antenna element 132) for different resistance values of the isolation resistance 151. The experimental results show that, when the isolation resistance 151 exhibits a resistance value of greater than or equal to 10 kΩ, the first antenna element 131 and the second antenna element 132 are sufficiently isolated from each other to generate power that enables, for example, charging. In other words, power can be harvested from the energy harvester 601 if the isolation resistance 151 exhibiting a resistance value of greater than or equal to 10 kΩ is inserted between the first antenna element 131 and the second antenna element 132. Thus, the isolation resistance 151 favorably exhibits a resistance value of greater than or equal to 10 kΩ.

Note that the resistance value of the isolation resistance 151 is not limited thereto, and, for example, the isolation resistance 151 exhibiting a resistance value of less than or equal to 10 kΩ may be used depending on, for example, how to use the energy harvester 601.

For example, a GND (the power supply GND 135) of a power supply board that includes, for example, an inverter circuit is connected in some cases to a metallic portion (the other conductor 136) such as a metallic case that is provided to an apparatus and other than the power supply GND 135 such that resistance between the power supply GND 135 and the other conductor 136 are substantially zero. In this case, the power supply GND 135 and the other conductor 136 serve as a single conductor. This results in difficulty in using the power supply GND 135 and the other conductor 136 as antenna elements.

On the other hand, in the energy harvester 601, the power supply GND 135 is isolated from the other conductor 136 by the isolation resistance 151. This makes it possible to cause the power supply GND 135 to serve as the first antenna element 131, and to cause the other conductor 136 to serve as the second antenna element 132. When conductors are isolated from each other within an apparatus in advance, as described above, this makes it possible to harvest a larger amount of power, compared to when, for example, an energy harvester is provided outside of the apparatus and used by being connected to the apparatus.

FIG. 24 is a circuit diagram illustrating another example of the configuration of the energy harvester including the isolation section. An energy harvester 602 illustrated in FIG. 24 includes a filter 152 that serves as the isolation section 150. Note that the energy harvester 602 is used by being included in an apparatus that is not grounded to the earth ground, as in the case of the energy harvester 601 illustrated in FIG. 23.

The filter 152 is configured to connect the first antenna element 131 and the second antenna element 132 with a relatively low direct-current resistance and to reduce passage of an alternating-current component having a specific frequency. Here, the specific frequency is, for example, a frequency of electric-field energy that is to be harvested by the energy harvester 602. For example, an element or circuit that exhibits a low direct-current resistance for a direct-current component, and exhibits a high impedance for an alternating-current component having the specific frequency is used as the filter 152.

The use of the filter 152 results in preventing an alternating-current component from easily flowing between the power supply GND 135 serving as the first antenna element 131 and the other conductor 136 serving as the second antenna element 132, and thus, the antenna section 130 serves as a dipole-structure antenna.

Further, the use of the filter 152 results in the power supply GND 135 and the other conductor 136 being connected to each other with a low direct-current resistance. This results in the other conductor 136 also serving as a portion of the power supply GND 135, and thus in being able to make the area of a GND larger in substance. This makes it possible to sufficiently stabilize a potential of the power supply GND 135.

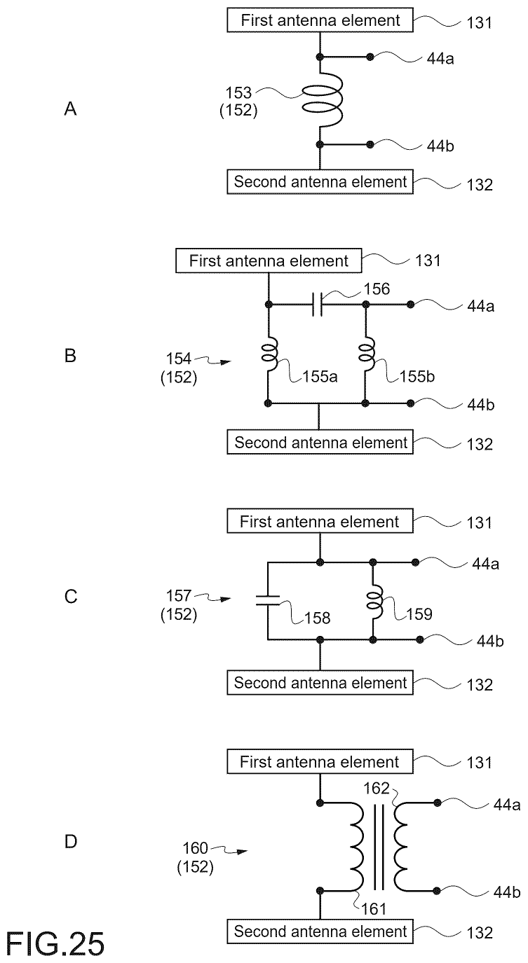

FIG. 25 is a set of circuit diagrams each illustrating an example of a configuration of the filter.

In A of FIG. 25, a coil 153 is used as the filter 152. One of terminals of the coil 153 is connected to the first antenna element 131 and to the connection point 44a of the rectifier circuit 141, and another of the terminals of the coil 153 is connected to the second antenna element 132 and to the connection point 44b of the rectifier circuit 141.

Further, inductance of the coil 153 is set to, for example, 100 mH or more. This makes it possible to separate an alternating-current component having a relatively high frequency (of, for example, greater than or equal to 100 MHz) and to harvest power of the alternating-current component.

In B of FIG. 25, a high-pass filter circuit 154 is used as the filter 152. The high-pass filter circuit 154 is a circuit that is a so-called Chebyshev high-pass filter, and includes a first coil 155a, a second coil 155b, and a capacitor 156. One of terminals of the first coil 155a is connected to the first antenna element 131 and to one of ends of the capacitor 156. One of terminals of the second coil 155b is connected to another of the ends of the capacitor 156 and to the connection point 44a of the rectifier circuit 141. Further, another of the terminals of the first coil 155a and another of the terminals of the second coil 155b are each connected to the second antenna element 132 and to the connection point 44b of the rectifier circuit 141.

When, for example, a single coil is used as the filter 152, the coil exhibits inductance having a very large value (of, for example, several hundred henrys) in order to separate a 50-Hz (or 60-Hz) alternating-current signal that is used as an AC power supply. This results in making the coil larger in size.

On the other hand, the use of the high-pass filter circuit 154 makes it possible to achieve a high impedance (of, for example, greater than or equal to 100 kΩ) for a 50-Hz (or 60-Hz) alternating-current signal even if the first coil 155a and the second coil 155b each exhibit low inductance. For example, in order to form the high-pass filter circuit 154 intended for 50 Hz, inductance of the first coil 155a and inductance of the second coil 155b are each set to 22 mH, and a capacity of the capacitor 156 is set to 470 μF. Further, the first coil 155a and the second coil 155b each exhibit a direct-current resistance of about 22Ω.

In C of FIG. 25, a parallel resonant circuit 157 is used as the filter 152. The parallel resonant circuit 157 is a circuit that exhibits a high impedance at a specified frequency, and includes a capacitor 158 and a coil 159. The capacitor 158 and the coil 159 are connected in parallel to each other between the first antenna element 131 and the second antenna element 132. Further, the connection point 44a of the rectifier circuit 141 is connected to the first antenna element 131, and the connection point 44b of the rectifier circuit 141 is connected to the second antenna element 132.

It is conceivable that, when, for example, the high-pass filter circuit 154 is used as the filter 152, a high impedance could be achieved at 50 Hz (or 60 Hz) due to a frequency response of a capacitor but there could be a reduction in impedance in a higher-frequency band.

On the other hand, the use of the parallel resonant circuit 157 makes it possible to achieve a high impedance at a specific frequency. Thus, for example, a frequency component of electric-field energy induced in the apparatus can be checked in advance, and a high impedance can be achieved for the frequency. For example, in order to form the parallel resonant circuit 157 having the characteristics of exhibiting a maximum impedance at 100 kHz, inductance of the coil 159 is set to 10 mH, and a capacity of the capacitor 158 is set to 0.5 μF. Here, the coil exhibits a direct-current resistance of about 0.04 Ω.

In D of FIG. 25, a transformer 160 is used as the filter 152. The transformer 160 includes a primary winding 161 and a secondary winding 162. One of terminals of the primary winding 161 is connected to the first antenna element 131, and another of the terminals of the primary winding 161 is connected to the second antenna element 132. One of terminals of the secondary winding 162 is connected to the connection point 44a of the rectifier circuit 141, and another of the terminals of the secondary winding 162 is connected to the connection point 44b of the rectifier circuit 141. When the transformer 160 is used, as described above, the circuit section 140 of the energy harvester 602 is completely separated from the apparatus in terms of direct current. This results in not causing, for example, a short circuit in the circuit section 140 during use of the energy harvester 602. This makes it possible to improve safety.

For example, the coil 153, the high-pass filter circuit 154, the parallel resonant circuit 157, or the transformer 160 depending on a frequency of harvesting-target power, is connected between the first antenna element 131 the second antenna element 132, as described above. This makes it possible to exhibit a very low resistance for direct current, and thus to increase resistance (an impedance) according to a frequency of harvesting-target power. This results in being able to obtain a stable power supply GND 135 and to efficiently harvest power.

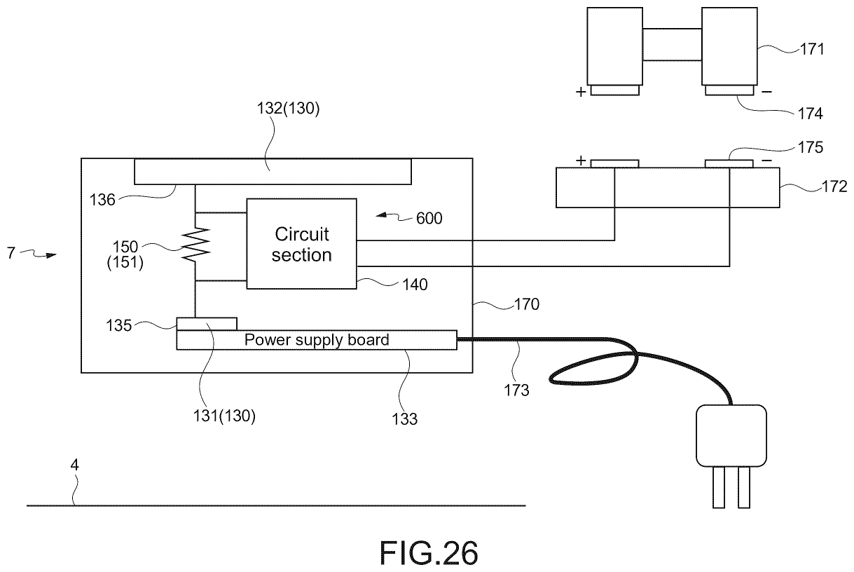

FIGS. 26, 27, and 28 each schematically illustrate an example of an apparatus that includes an energy harvester that includes an isolation section. A configuration obtained when an energy harvester 600 that includes the isolation section 150 is included in an apparatus that is not grounded to the earth ground 4, is described below.

FIG. 26 illustrates an example in which the energy harvester 600 is applied to a game device 7. The game device 6 includes a game device body 170, a wireless game controller 171, and a charging base 172 used to charge the game controller 171. The energy harvester 600 is included inside of the game device body 170, and supplies the charging base 172 with power used to charge the game controller 171.

The game device body 170 is connected to an AC power supply, and is used without being grounded to the earth ground 4. The game device body 170 includes a power supply board 133, the power supply GND 135, and the other conductor 136. Further, the game device body 170 is provided with the circuit section 140 and the isolation section 150 that are included in the energy harvester 600.

The power supply board 133 is connected to the AC power supply through a bipolar AC code 173. For example, the power supply board 133 is provided with, for example, a converter circuit that converts 50-Hz (or 60-Hz) alternating-current power into direct-current power. The power supply board 133 is a generation source that generates a relatively greater amount of electric-field energy in the game device body 170 due to, for example, noise generated by the converter circuit.

The power supply GND 135 is a ground pattern that is provided on the power supply board 133. Note that the power supply GND 135 is not connected to the earth ground 4, and is a conductor that is above the earth ground 4.

The other conductor 136 is a conductor such as a metallic case or heat-dissipation plate that is provided to the game device body 170.

In the game device 7, the antenna section 130 of the energy harvester 600 is formed by the power supply GND 135 and the other conductor 136. In other words, the power supply GND 135 is used as the first antenna element 131, and the other conductor 136 is used as the second antenna element 132.

The isolation section 150 is connected between the power supply GND 135 serving as the first antenna element 131 and the other conductor 136 serving as the second antenna element 132. Here, the isolation resistance 151 is used as the isolation section 150. However, one of the filters 152 illustrated in, for example, FIGS. 24 and 25 may be used.

The circuit section 140 stores therein power output from the antenna section 130, and outputs the stored power as necessary. The circuit section 140 includes, for example, a rectifier circuit, a power storing section, and a power storing element. Output from the antenna section 130 is rectified by the rectifier circuit. Thereafter, the output is charged to the power storing element through the power storing section.

The game controller 171 is a wireless controller used by a user to input an operation, and includes a battery (not illustrated), and a charging terminal 174 used to charge the battery.

The charging base 172 is a base used to charge the game controller 171, and includes a charging terminal 175 that is connected to the charging terminal 174 of the game controller 171. Power stored in the circuit section 140 is supplied to the charging terminal 175 through a cable. For example, energy of an electric field generated in, for example, a converter circuit of the power supply board 133 during operation of the game device 7, is harvested using the power supply GND 135 and the other conductor 136 as an antenna, and is charged to the power storing element of the circuit section 140. Further, when the game controller 171 is charged, the game controller 171 is placed on the charging base 172, and the charging terminal 174 of the game controller 171 and the charging terminal 175 of the charging base 172 are connected to each other. The circuit section 140 supplies power to the charging terminal 175 from the power storing element when, for example, connection established between the charging terminal 174 and the charging terminal 175 is detected. This results in the game controller 171 being charged with power harvested by the energy harvester 600.

In the example illustrated in FIG. 26, the charging base 172 and the game device body 170 are separate housings. However, the charging base 172 may be provided to the game device body 170 to be integrated with the game device body 170. Further, a connector used to output power coming from the circuit section 140 may be provided to the game device body 170. In this case, a connector used to connect the charging base 172 to the connector of the game device body 170, is provided to a cable connected to the charging base 172. Alternatively, the game controller 171 may be directly connected to the connector of the game device body 170 without the charging base 172 being used. Such a configuration makes it possible to charge various kinds of the game controller 171 using power harvested by the energy harvester 600. Further, all of, or a portion of the circuit section 140 provided to the game device body 170 may be provided to the charging base 172 or the game controller 171.

Note that it is conceivable that, for example, a LAN cable or an HDMI (registered trademark) cable could be connected to the game device body 170. In general, a shield portion used to shield wiring is provided to a connector of the cable. It is conceivable that, when, for example, the shield portion of the connector is connected to the earth ground 4, there could be a reduction in the efficiency in harvesting of power that is performed by the energy harvester 600. In this case, the reduction in the efficiency in harvesting power can be avoided by preventing the shield portion included in the connector and connected to the earth ground 4 from being connected to the power supply GND 135.

Note that transmission of a signal using the communication cable described above is differential transmission in principle, and thus is less likely to be affected by extraneous noise or a ground. This makes it possible to perform communication properly even if the shield portion of the connector and the power supply GND 135 are not connected to each other.

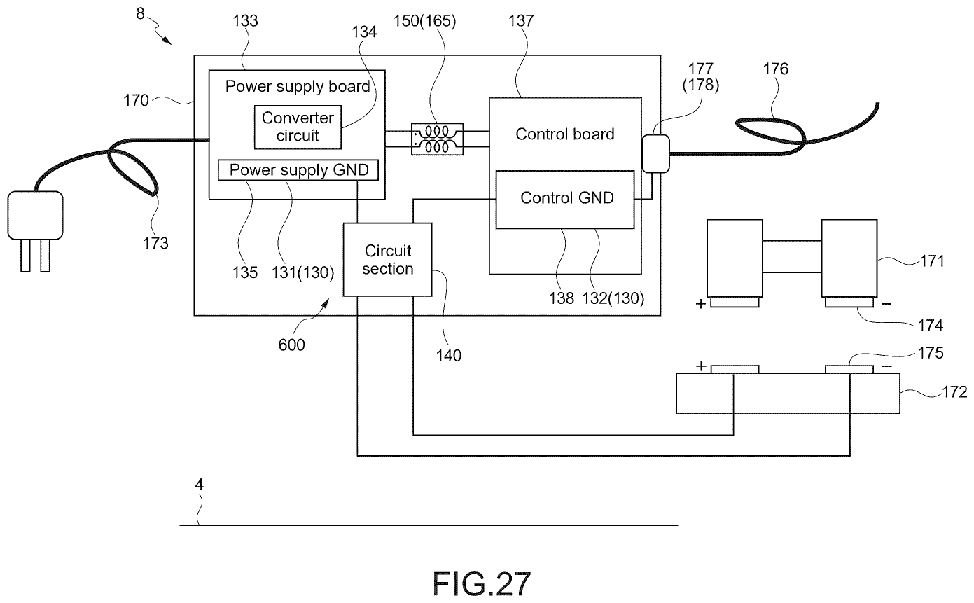

FIG. 27 illustrates an example in which the energy harvester 600 is applied to a game device 8. The energy harvester 600 is included inside of the game device body 170, and supplies the charging base 172 with power used to charge the game controller 171. In FIG. 27, the energy harvester 600 situated inside of the game device 8 has a configuration that is different from the configuration of the energy harvester 600 situated inside of the game device 7 illustrated in FIG. 26.

The game device body 170 includes the power supply board 133, a converter circuit 134, the power supply GND 135, a control board 137, and a control GND 138 that is provided to the control board 137, where the converter circuit 134 and the power supply GND 135 are provided to the power supply board 133. Further, the game device body 170 is provided with the circuit section 140 and the isolation section 150 that are included in the energy harvester 600.

The power supply board 133 is connected to an AC power supply, and supplies 50-Hz (or 60-Hz) alternating-current power to the converter circuit 134. The converter circuit 134 converts the alternating-current power into direct-current power. The direct-current power output from the converter circuit 134 is supplied to the control board 137. The power supply GND 135 is a ground pattern that is provided on the power supply board 133, and is used as a GND of, for example, the converter circuit 134. Note that the power supply GND 135 is not connected to the earth ground 4.

The control board 137 is a board on which a computing unit that includes, for example, a CPU and a memory is mounted, and performs various computing processing necessary to operate the game device 8. The control GND 138 is a ground pattern that is provided on the control board 137. Further, an electric communication cable 176 used to perform electric communication external to the game device body 170 is connected to the control board 137.

The electric communication cable 176 is, for example, a LAN cable or an HDMI (registered trademark) cable, and includes a connector 177 used to connect the electric communication cable 176 to the game device body 170. Further, the connector 177 includes a shield portion 178 that is grounded to the earth ground 4. When, for example, the electric communication cable 176 is connected to the game device body 170, the shield portion 178 of the connector 177 is connected to the control GND 138 of the control board 137. In this case, the control GND 138 is a conductor that is grounded to the earth ground 4.

In the game device 8, the antenna section 130 of the energy harvester 600 is formed by the power supply GND 135 and the control GND 138. In other words, the power supply GND 135 is used as the first antenna element 131, and the control GND 138 is used as the second antenna element 132.

Note that, in FIG. 27, the control GND 138 provided on the control board 137 is used as the second antenna element 132. However, for example, a ground pattern provided on any board that is different from the power supply board 133 may be used as the second antenna element 132.

Direct-current power obtained by conversion performed by the converter circuit 134 is supplied to the control board 137 through a power line formed by a pair of pieces of wiring. For example, one of the pair of pieces of wiring is connected to the power supply GND 135 on the power supply board 133 and the control GND 138 on the control board 137.

Thus, in the game device 8, a common mode choke coil 165 is provided on the power line. The common mode choke coil 165 serves as the isolation section 150 isolating the power supply GND 135 serving as the first antenna element 131 from the control GND 138 serving as the second antenna element 132. Further, the common mode choke coil 165 is an example of the filter 152 described above.

The provision of the common mode choke coil 165 results in preventing an alternating-current component including electric-field energy from easily flowing between the power supply GND 135 and the control GND 138. This makes it possible to cause the power supply GND 135 and the control GND 138 to respectively serve as antenna elements isolated from each other.

Note that, with respect to a direct-current component, the common mode choke coil 165 serves as normal wiring that exhibits a sufficiently low direct-current resistance. Thus, direct-current power coming from the converter circuit 134 is supplied to the control board 137 without, for example, being lost due to the direct-current resistance of the common mode choke coil 165. As described above, the energy harvester 600 illustrated in FIG. 27 has a configuration in which the power supply GND 135 of the power supply board 133 including the converter circuit 134 generating much noise serves as the first antenna element 131 and the control GND 138 of the control board 137 (or a GND of another board) serves as the second antenna element 132.

When, for example, the electric communication cable 176 grounded to the earth ground 4 is connected to the control board 137, electric-field energy included in, for example, noise of the converter circuit 134 can be harvested without being allowed to escape into the earth ground 4, since the power supply board 133 generating more noise is isolated. Further, the control GND 138 is connected to the earth ground 4 through the electric communication cable 176. Consequently, the second antenna element 132 substantially has a longer antenna length, and this makes it possible to obtain a very large amount of power.

Note that, depending on, for example, the configuration of the apparatus, it may be difficult to implement the isolation resistance 151 or the filter 152. In such a case, a metallic portion that is capacitively coupled to a noise generation source is provided, and, instead of the power supply GND 135, the metallic portion can be used as the first antenna element 131. For example, a metallic pattern for capacitive coupling is provided on a back surface of the power supply GND 135, and the energy harvester 600 is formed, with the metallic pattern being used as the first antenna element 131.

The example in which the energy harvester 600 is applied to the game device 7 and Y has been described in FIGS. 26 and 27. Likewise, the energy harvester 600 can also be applied to products such as television, hard disk recorder, and stereo component.

Further, the example in which output from the energy harvester 600 is used to charge the wireless game controller 171 (a remote controller) has been described above. In addition to these examples, the energy harvester 600 can also be used as an internal battery of an apparatus, or a power supply for sensors that perform, for example, measurement of a temperature in an apparatus.

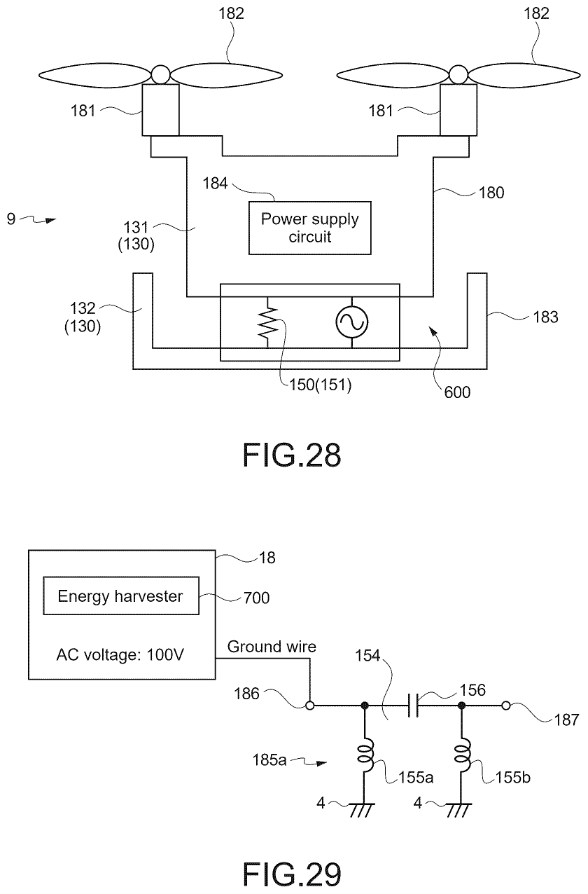

FIG. 28 illustrates an example in which the energy harvester 600 is applied to a drone 9. The drone 9 is an apparatus that flies by being remotely controlled by a controller situated on the ground. The drone 9 includes a body 180, a motor 181, a rotor 182, and a metallic frame 183.

The body 180 is a housing that accommodates therein, for example, various circuits and a drive source that are used to operate the drone 9, and, for example, the body 180 is formed using, for example, a metallic case. The body 180 accommodates therein, for example, a control circuit that controls the operation of the drone 9, a battery section that serves as a drive source, and a power supply circuit 184 that is a noise source that rotates the motor 181 using power supplied by the battery section. Further, a circuit section (not illustrated) of the energy harvester 600 is provided to the body 180.

The body 180 includes a plurality of support shafts each extending substantially horizontally, and the motor 181 serving as a drive source for the rotor 182 is attached to a top surface of each support shaft. The rotor 182 is attached to a rotational shaft of each motor 181.

The metallic frame 183 is attached to a lower portion of the body 180. For example, an image-capturing apparatus (not illustrated) and a conveyance apparatus (not illustrated) are fixed to the metallic frame 183.

As illustrated in FIG. 28, the isolation section 150 is inserted between upper structural elements including the body 180, the motor 181, and the rotor 182, and lower structural elements including the metallic frame 183. Here, the isolation resistance 151 exhibiting a resistance value of greater than or equal to 10 kΩ is used as the isolation section 150. However, for example, the filter 152 may be used.

The insertion of the isolation section 150 results in isolating the upper structural elements from the lower structural elements in the drone 9. The upper structural elements serve as the first antenna element 131 capacitively coupled to the power supply circuit 184 corresponding to a noise source. Further, the lower structural elements serve as the second antenna element 132 isolated from the first antenna element 131.

The motor 181 attached to the body 180 is operated to rotate the rotor 182. Accordingly, the drone 9 flies. Thus, the power supply circuit 184 of the drone 9 includes an inverter circuit used to control a motor, and noise of different frequencies is generated.

An upper mechanism including the power supply circuit 184 corresponding to a noise source is isolated from a lower mechanism by the isolation section 150 (the isolation resistance 151). This makes it possible to draw a large amount of power, as in the case of the game devices, by the circuit section of the energy harvester 600 being connected to the upper mechanism and the lower mechanism. Power harvested by the energy harvester 600 can be used as a power supply used to drive various sensors such as a temperature sensor and a humidity sensor.

In FIG. 28, the drone 9 is an example of an apparatus that operates in a state of being above the earth ground 4. However, the present technology can also be applied to mobile objects such as automobiles and buses.

For example, a tire of an automobile is grounded to the earth ground 4 by use of a grounding resistance of about 10 MΩ, in order to cause static electricity to escape. With a resistance of greater than or equal to 10 kΩ, the energy harvester 600 provides a state of being above the earth ground 4 (refer to, for example, FIG. 23).

Thus, when the energy harvester 600 is applied to a mobile object such as an automobile that travels on the ground by its tires being rotated, a chassis of the mobile object is used as the first antenna element 131, where an engine and a power supply are concentrated in the chassis. Further, metallic bodies such as a door and a hood are isolated from the chassis using the isolation section 150, and this enables the metallic bodies to be used as the second antenna element 132. The circuit section is connected to the first antenna element 131 and second antenna element 132 having the configuration described above, and this makes it possible to draw a large amount of power. Power harvested by the energy harvester 600 can be used as a power supply used to drive various sensors such as a motion sensor.

FIGS. 29, 30, and 31 are circuit diagrams each illustrating an example of a ground circuit of an apparatus that includes an energy harvester. The example in which the energy harvester is included in the apparatus being used in a state of not being grounded to the earth ground 4 has been described above. Here, examples of ground circuits that are each used when an energy harvester 700 is included in an apparatus 18 that is to be grounded to the earth ground 4 are described.

In general, an apparatus for which it is specified in safety standards that the apparatus has to be grounded to the earth ground 4 as measures against short circuit in order to prevent an electric shock to a human body, is known. In this case, there is also a need to connect a GND of a power supply board to the earth ground 4. Consequently, all of energy induced in the apparatus escapes into the earth ground 4, and thus voltage is not induced.

Referring to the safety standards currently applied in Japan, examples of the apparatus 18 to which the energy harvester 700 is applied include an apparatus for which Class D grounding (hereinafter referred to as D grounding) is necessary. The D grounding is grounding performed on machinery and appliances of a low voltage that is lower than or equal to 300 V, metallic casings, and metallic tubes. For example, the D grounding is performed on an apparatus, from among apparatuses used by being connected to a power supply of an alternating current of 100 V, that is to be grounded. For example, grounding of apparatuses such as microwaves, refrigerators, washing machines, driers, air conditioners, dehumidifiers, various measurement devices, factory robots, and server apparatuses is compliant with the standards. Such apparatuses are used on the basis of the D grounding.

In the following description, it is assumed that the D grounding is performed on the apparatus 18 to which the energy harvester 700 is applied. The grounding resistance in which direct-current resistance is less than or equal to 100Ω is desired when the D grounding is performed. Note that the grounding resistance in which the direct-current resistance is less than or equal to 500Ω may be used in the case in which an apparatus is provided that automatically breaks a low tension circuit within 0.5 seconds when a ground fault (a short circuit) occurs in the circuit. For example, a change in grounding resistance from 100Ω to 500Ω is approved in the D grounding when there is a mechanism that stops, upon detecting dark current, power supplied to an apparatus. Note that, for example, the isolation resistance 151 illustrated in, for example, FIG. 23 exhibits a direct-current resistance value of greater than or equal to 10 kΩ. Thus, it is difficult to use the isolation resistance 151 upon the D grounding.

FIG. 29 is a circuit diagram of a ground circuit 185a formed using the high-pass filter circuit 154 described with reference to B of FIG. 25. An input terminal 186 of the high-pass filter circuit 154 is connected to a ground wire of the apparatus 18. One of the terminals of the first coil 155a is connected to the input terminal 186 and to one of the ends of the capacitor 156. One of the terminals of the second coil 155b is connected to another of the ends of the capacitor 156 and to an output terminal 187. Further, another of the terminals of the first coil 155a and another of the terminals of the second coil 155b are each connected to the earth ground 4. Note that the output terminal 187 of the high-pass filter circuit 154 is open.

Further, in the energy harvester 700 included in the apparatus 18, for example, a power supply GND connected to the ground wire of the apparatus 18 is used as the first antenna element 131, and a conductor that is different from the first antenna element 131 is used as the second antenna element 132.

The first coil 155a is inserted on an input side of the high-pass filter circuit 154. A direct-current resistance value of the first coil 155a is set such that the safety standards are satisfied. This makes it possible to achieve a high impedance (of greater than or equal to 100 kΩ) for a 50-Hz (or 60-Hz) alternating-current signal while performing the D grounding.

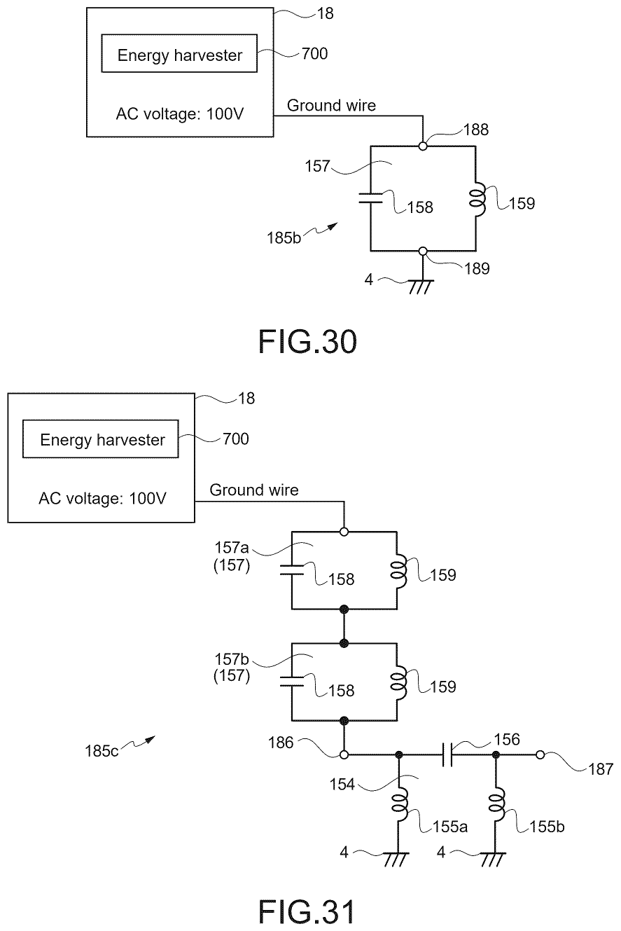

FIG. 30 is a circuit diagram of a ground circuit 185b formed using the parallel resonant circuit 157 described with reference to C of FIG. 25. An input terminal 188 of the parallel resonant circuit 157 is connected to the ground wire of the apparatus 18. The capacitor 158 and the coil 159 are connected in parallel to each other between the input terminal 188 and an output terminal 189. The output terminal 189 is connected to the earth ground 4.

As described above, the parallel resonant circuit 157 has a configuration in which the capacitor 158 and the coil 159 are inserted in parallel with each other between the ground wire of the apparatus 18 and the earth ground 4. This makes it possible to achieve a high impedance at a frequency of electric-field energy desired to be induced in the apparatus 18 to be harvested. Further, with respect to a direct-current component, the coil 159 exhibits a sufficiently low direct-current resistance. Thus, the D grounding satisfying the safety standards can be performed.

FIG. 31 is a circuit diagram of a ground circuit 185c formed by combining two parallel resonant circuits 157a and 157b and the high-pass filter circuit 154. The parallel resonant circuits 157a and 157b are connected in series between the ground wire of the apparatus 18 and the input terminal 186 of the high-pass filter circuit 154. The output terminal 187 of the high-pass filter circuit 154 is open.

When the high-pass filter circuit 154 and the parallel resonant circuit 157 (at least one parallel resonant circuit 157) are combined, as described above, this makes it possible to capture electric-field energy depending on various frequency components induced in the apparatus 18 while satisfying the safety standards for performing the D grounding on the apparatus 18 using the ground wire. Note that one of the high-pass filter circuit 154 and the parallel resonant circuit 157 may be used alone according to a frequency component of energy of an electric field generated in the apparatus 18, or two or more thereof may be used in combination as appropriate according to a frequency at which harvesting is performed, such that the resistance value in the safety standards is satisfied.

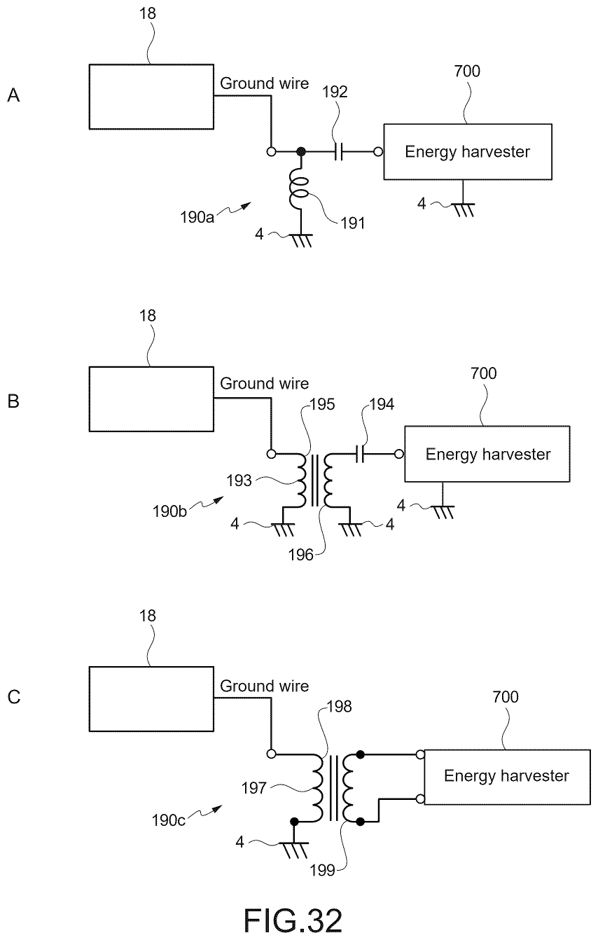

FIG. 32 is a set of circuit diagrams each illustrating an example of a configuration of a circuit for measures against short circuit. The ground circuit that performs the D grounding in a state in which the apparatus 18 is above the earth ground at a frequency at which harvesting is performed, is described above. Here, a circuit for measures against short circuit that is used to prevent current from flowing into the energy harvester 700 when a short circuit is caused in the apparatus 18, is described. Note that FIG. 32 illustrates the energy harvester 700 outside of the apparatus 18. However, the energy harvester 700 may be provided inside of or outside of the apparatus 18.

A of FIG. 32 is a circuit diagram of a circuit 190a for measures against short circuit that is formed using a high-pass filter. Here, the ground wire of the apparatus 18 is connected to the earth ground 4 through a coil 191. Further, a connection point of the ground wire and the coil 191 is connected to the energy harvester 700 as the first antenna element 131 through a capacitor 192. Further, the second antenna element 132 is the earth ground 4, or an antenna such as a copper-foil meander line antenna on a board. In this case, the capacitor 192 is situated between the ground wire and the energy harvester 700. Thus, current from the apparatus 18 that passes through the ground wire and flows into the earth ground 4 does not flow into the energy harvester 700.

B of FIG. 32 is a circuit diagram of a circuit 190b for measures against short circuit that is formed using a transformer 193 and a capacitor 194. One of terminals of a primary winding 195 of the transformer 193 is connected to the ground wire of the apparatus 18, and another of the terminals of the primary winding 195 is connected to the earth ground 4. Further, one of terminals of a secondary winding 196 of the transformer 193 is connected to the energy harvester 700 as the first antenna element 131 through the capacitor 194, and another of the terminals of the secondary winding 196 is connected to the earth ground 4. Note that, in B of FIG. 32, the earth ground 4 is used as the second antenna element 132. In this case, the transformer 193 and the capacitor 194 are situated between the ground wire and the energy harvester 700. Thus, current from the apparatus 18 does not flow into the energy harvester 700 upon occurrence of a short circuit.

C of FIG. 32 is a circuit diagram of a circuit 190c for measures against short circuit that is formed using a transformer 197. One of terminals of a primary winding 198 of the transformer 197 is connected to the ground wire of the apparatus 18, and another of the terminals of the primary winding 198 is connected to the earth ground 4. Further, one of terminals of a secondary winding 199 of the transformer 197 is connected to the energy harvester 700 as the first antenna element 131, and another of the terminals of the secondary winding 199 is connected to the energy harvester 700 as the second antenna element 132. In this case, the ground wire is isolated from the energy harvester 700 by the transformer 197. Thus, current from the apparatus 18 does not flow into the energy harvester 700 upon occurrence of a short circuit.

As described above, the circuit for measures against short circuit that is formed using a high-pass filter or a transformer makes it possible to completely isolate the apparatus 18 from the energy harvester 700. Thus, a large amount of current will not flow into the energy harvester 700 even if, for example, a short circuit is caused in the apparatus 18. This results in improving safety.

Further, in the case of the apparatus 18 using, for example, a three-terminal plug that includes a GND line, the use of one of the configurations illustrated in FIG. 32 makes it possible to provide the energy harvester 700 to a plug portion of the apparatus 18. This makes it possible to harvest energy from the entirety of the apparatus 18 safely with a simple configuration.

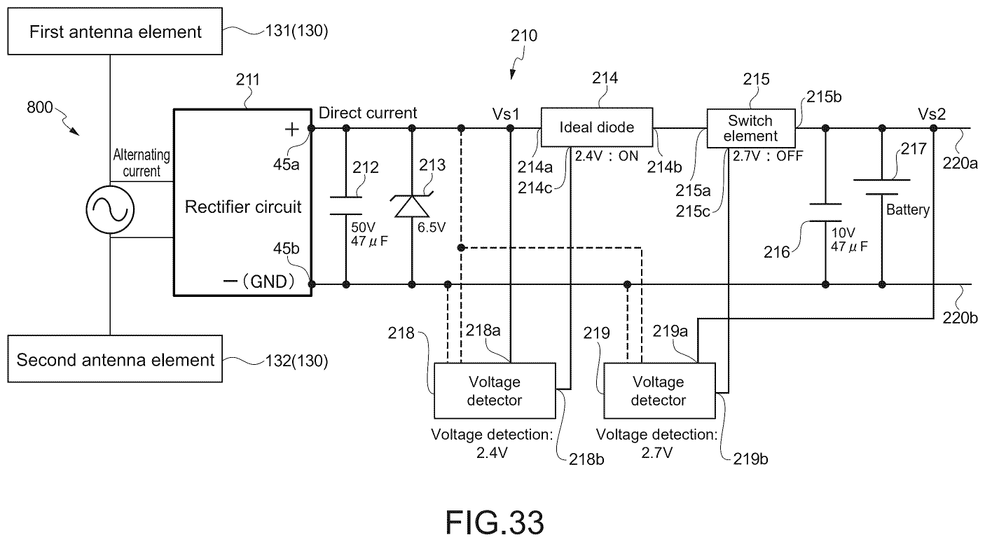

FIG. 33 is a circuit diagram illustrating an example of a configuration of an energy harvester 800 that is compatible with a high voltage. The energy harvester 800 includes the antenna section 130 including the first antenna element 131 and the second antenna element 132, and a circuit section 210 used to charge, to a battery 217, output from the antenna section 130. Here, a configuration that enables the battery 217 to be charged properly even when voltage (a direct-current voltage) obtained by output (an alternating-current voltage) from the antenna section 130 being rectified is higher than a charge voltage of the battery 217, is described.

The circuit section 210 includes a rectifier circuit 211, a first capacitor 212, a Zener diode 213, an ideal diode 214, a switch element 215, a second capacitor 216, the battery 217, a first voltage detector 218, and a second voltage detector 219. Further, a positive voltage line 220a and a negative voltage line 220b are provided to the circuit section 210.

The rectifier circuit 211 rectifies an alternating-current voltage output from the antenna section 130, and outputs the rectified voltage through the output terminal 45a and the output terminal 45b as a direct-current voltage. The output terminal 45a is connected to the positive voltage line 220a, and the output terminal 45b is connected to the negative voltage line 220b. For example, the rectifier circuit 211 is a full-wave rectifier circuit that is formed using a diode of which a withstand voltage is about 50 V. Thus, the rectifier circuit 211 outputs a direct-current voltage of about 50 V at most.

The first capacitor 212 is provided on an output side of the rectifier circuit 211 and connected between the positive voltage line 220a and the negative voltage line 220b. A withstand voltage of the first capacitor 212 is set such that the first capacitor 212 can deal with the maximum direct-current voltage output by the rectifier circuit 211. In the example illustrated in FIG. 33, the withstand voltage of the first capacitor 212 is 50 V, and a capacity of the first capacitor 212 is 47 μF.

The Zener diode 213 is provided on an output side of the first capacitor 212, where a cathode of the Zener diode 213 is connected to the positive voltage line 220a, and an anode of the Zener diode 213 is connected to the negative voltage line 220b. The Zener diode 213 is turned on when a voltage higher than a certain voltage (a so-called Zener voltage) is applied to the Zener diode 213, and causes current to escape into the negative voltage line 220b from the positive voltage line 220a. Note that a voltage across the Zener diode 213 is maintained at the Zener voltage even when there is a change in current value. In the example illustrated in FIG. 33, the Zener diode 213 of which the Zener voltage is 6.5 V is used.

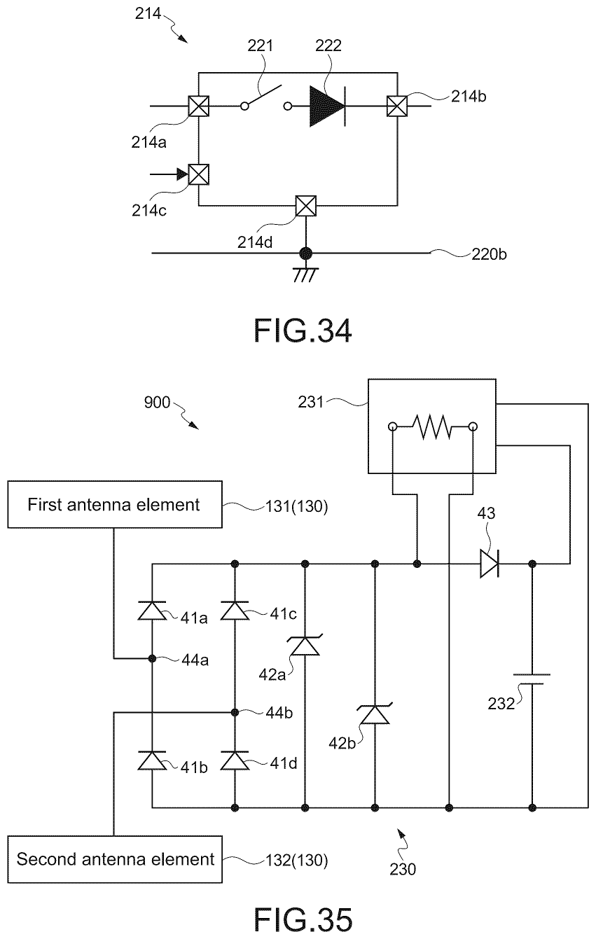

FIG. 34 is a circuit diagram illustrating an example of a configuration of the ideal diode 214. The ideal diode 214 is a diode element that is turned on and off by switching being performed by a control signal.

The ideal diode 214 includes an input terminal 214a, an output terminal 214b, a control terminal 214c, and a GND terminal 214d. Further, the ideal diode 214 includes a switch element 221 and a diode 222. An anode of the diode 222 is connected to the input terminal 214a through the switch element 221, and a cathode of the diode 222 is connected to the output terminal 214b. The control terminal 214c is a terminal through which a control signal is input. The GND terminal 214d is connected to the negative voltage line 220b.

Switching is performed to turn on and off the switch element 221 according to a control signal input through the control terminal 214c. Thus, the ideal diode 214 serves as the diode 222 when the switch element 221 is on. In this case, for example, backflow of current from the output terminal 214b to the input terminal 214a can be prevented. Further, a path between the input terminal 214a and the output terminal 214b is interrupted when the switch element 221 is off. It can be said that the ideal diode 214 is an element that includes a switch function and a backflow prevention function, as described above.

As illustrated in FIG. 33, the ideal diode 214 is provided on an output side of the Zener diode 213 on the positive voltage line 220a. Specifically, the input terminal 214a and the output terminal 214b are placed on the positive voltage line 220a such that the input terminal 214a is situated on the side of the rectifier circuit 211. Note that an illustration of the GND terminal 214d is omitted in FIG. 33. Further, the control terminal 214c is connected to a control terminal 218b of the first voltage detector 218.

For example, the use of a single diode may result in current flowing backward slightly when a voltage across the diode is changed and voltage is applied in a reverse direction. On the other hand, the provision of the switch element 221 on an input side of the diode 222 in the ideal diode 214 makes it possible to prevent reverse current from being caused. This makes it possible to prevent current from being leaked from the battery 217 provided on an output side of the ideal diode 214.

The switch element 215 includes an input terminal 215a, an output terminal 215b, and a control terminal 215c, and controls an on state and an off state of a path between the input terminal 215a and the output terminal 215b according to a control signal that is input through the control terminal 215c. The switch element 215 is provided on the output side of the ideal diode 214 on the positive voltage line 220a. Specifically, the input terminal 215a and the output terminal 215b are placed on the positive voltage line 220a such that the input terminal 215a is situated on the side of the rectifier circuit 211. Further, the control terminal 215c is connected to a control terminal 219b of the second voltage detector 219. The switch element 215 is formed using, for example, an FET.

The second capacitor 216 is provided on an output side of the switch element 215 and connected between the positive voltage line 220a and the negative voltage line 220b. A withstand voltage of the second capacitor 216 is set such that the second capacitor 216 can deal with a voltage higher than the Zener voltage of the Zener diode 213. In the example illustrated in FIG. 33, the withstand voltage of the second capacitor 216 is 10 V, and a capacity of the second capacitor 216 is 47 μF.

The battery 217 is provided on an output side of the second capacitor 216. A cathode of the battery 217 is connected to the positive voltage line 220a, and an anode of the battery 217 is connected to the negative voltage line 220b. Here, the battery 217 of which a charge voltage is about 2.5 V and for which a voltage of the battery 217 in a state of being fully charged is 2.7 V, is assumed to be used.

The first voltage detector 218 and the second voltage detector 219 each include a detection terminal and a control terminal, and each output a control signal through the control terminal according to voltage detected by the detection terminal. Further, the first voltage detector 218 and the second voltage detector 219 are each driven by power supplied through the positive voltage line 220a and power supplied through the negative voltage line 220b. In FIG. 33, wiring through which power is supplied to the first voltage detector 218 and the second voltage detector 219 is indicated using dotted lines.

The detection terminal 218a of the first voltage detector 218 is connected on an input side of the ideal diode 214. Voltage at the detection terminal 218a (voltage on the input side of the ideal diode 214) is hereinafter referred to as a detected voltage Vs1. Further, the control terminal 218b of the first voltage detector 218 is connected to the control terminal 214c of the ideal diode 214. The first voltage detector 218 turns on the switch element 221 of the ideal diode 214 when the detected voltage Vs1 is higher than or equal to 2.4 V, and turns off the switch element 221 when the detected voltage Vs1 is less than 2.4 V.

The detection terminal 219a of the second voltage detector 219 is connected to the positive voltage line 220a on an output side of the battery 217. Voltage at the detection terminal 219a (voltage of the battery 217) is hereinafter referred to as a detected voltage Vs2. Further, the control terminal 219b of the second voltage detector 219 is connected to the control terminal 215c of the switch element 215. The second voltage detector 219 turns off the switch element 215 when the detected voltage Vs2 is higher than or equal to 2.7 V, and turns on the switch element 215 when the detected voltage Vs2 is less than 2.7 V.

An operation of the energy harvester 800 is described below. First, it is assumed that the detected voltage Vs1 (the voltage of the first capacitor 212) is less than 2.4 V and the detected voltage Vs2 (the voltage of the battery 217) is less than 2.7 V. This is a state in which there is a need to charge the battery 217 since, for example, power stored in the battery 217 is consumed and the voltage of the battery 217 is less than a voltage (2.7 V) of the battery 217 in a state of being fully charged.

When a direct-current voltage is output by the rectifier circuit 211, electric charges are stored in the first capacitor 212, and there is an increase in the voltage of the first capacitor 212, that is, the detected voltage Vs1. When the detected voltage Vs1 is higher than or equal to 2.4 V, the first voltage detector 218 outputs a control signal used to turn on the ideal diode 214. At this point, the detected voltage Vs2 is less than 2.7 V. Thus, the second voltage detector 219 outputs a control signal used to turn on the switch element 215. Consequently, both the ideal diode 214 and the switch element 215 are turned on.

When, for example, the voltage of the first capacitor 212 is higher than the voltage of the battery 217, current flows through the ideal diode 214 and electric charges stored in the first capacitor 212 are transferred to the battery 217. In other words, the battery 217 is charged by the first capacitor 212. At this point, the second capacitor 216 is also charged together with the battery 217.

Further, the transfer of electric charges to the second capacitor 216 and the battery 217 results in a decrease in the voltage of the first capacitor 212. However, when electric charges are stored in the first capacitor 212 due to the direct-current voltage output by the rectifier circuit 211, the voltage of the first capacitor 212 is increased again, and the second capacitor 216 and the battery 217 are charged.

Note that, when the voltage (the detected voltage Vs1) of the first capacitor 212 is less than 2.4 V, the first voltage detector 218 performs switching to turn off the ideal diode 214. On the other hand, when the detected voltage Vs1 is higher than or equal to 2.4 V by electric charges being stored in the first capacitor 212, the ideal diode 214 is turned on again, and this makes it possible to charge the battery 217.

In the energy harvester 800, an operation of transferring, to the battery 217 provided on the output side, electric charges stored in the first capacitor 212 provided on the input side is performed repeatedly, as described above. Consequently, the voltage (the detected voltage Vs2) of the battery 217 is gradually increased, and the battery 217 is charged.

When the detected voltage Vs2 is increased up to the voltage (2.7 V) of the battery 217 in a state of being fully charged, the second voltage detector 219 outputs a control signal used to turn off the switch element 215. Consequently, the switch element 215 is turned off, and charging of the battery 217 is stopped. This results in avoiding overcharging the battery 217. As described above, the switch element 215 serves as an overcharge prevention switch that prevents the battery 217 from being overcharged.

Here, the direct-current voltage output by the rectifier circuit 211 may be a voltage (for example, 40 V) that is sufficiently higher than a voltage in a range of a charge voltage (for example, 2.4 V to 2.7 V) used to charge the battery 217 properly.

For this reason, the withstand voltage of the first capacitor 212 provided just after the rectifier circuit 211 is set to a voltage (here, 50 V) such that the first capacitor 212 can deal with the maximum value of the direct-current voltage output by the rectifier circuit 211. Thus, when direct-current voltage that exceeds a voltage in the range of the charge voltage is applied, electric charges depending on the direct-current voltage can be stored in the first capacitor 212 without the first capacitor 212 getting broken.

Further, the Zener diode 213 is provided parallel to the first capacitor 212. Consequently, when, for example, the voltage of the first capacitor 212 is increased up to the Zener voltage, current flows into the negative voltage line 220b from the positive voltage line 220a, and the voltage of the first capacitor 212 is limited to the Zener voltage. This makes it possible to protect ICs included in the first voltage detector 218 and the second voltage detector 219.

Note that it is known that, actually, a very small protection current flows from the cathode to the anode in the Zener diode 213 even with a voltage lower than the Zener voltage. However, the Zener voltage (6.5 V) sufficiently higher than the voltage (2.7 V) of the battery 217 in a state of being fully charged, is set for the Zener diode 213 illustrated in FIG. 33. In this case, voltage with which current leaks is about 4 V when the Zener diode 213 is used. Thus, a protection current does not leak with a voltage less than or equal to the voltage of the battery 217 in a state of being fully charged. Consequently, power output by the antenna section 130 can be charged to the battery 217 with certainty.

Further, the second capacitor 216 of which a withstand voltage is higher than the Zener voltage set for the Zener diode 213, is provided on an input side of the battery 217.

When, for example, charging of the battery 217 is completed, the switch element 215 is turned off. The first capacitor 212 is continuously charged with a direct-current voltage when the switch element 215 is off. Thus, the voltage of the first capacitor 212 is continuously increased up to the Zener voltage.

On the other hand, when the battery 217 is used, power stored in the second capacitor 216 and power stored in the battery 217 are consumed, and there is a decrease in the voltages of the second capacitor 216 and the battery 217. Note that electric charges move faster in a capacitor than in a battery. Thus, electric charges are released faster from the second capacitor 216.

Here, when the voltage (the detected voltage Vs2) of the battery 217 is less than 2.7 V, the switch element 215 is turned on, and the battery 217 and the second capacitor 216 are connected to the first capacitor 212 again. At this point, the voltage of the first capacitor 212, which is applied on the output side of the switch element 215, is rapidly decreased by charging the second capacitor 216 from which electric charges are being released. In other words, the second capacitor 216 serves as a buffer that receives the voltage of the first capacitor 212, which has been increased up to the Zener voltage (6.5 V).

This makes it possible to avoid directly applying, to the battery 217, 6.5 V, which is the voltage of the Zener diode 213 on the input side upon reconnection due to the switch element 215.

Note that setting is performed such that the second capacitor 216 has a capacity similar to or larger than the capacity of the first capacitor 212. This enables the second capacitor 216 to sufficiently absorb, upon the reconnection, electric charges stored in the first capacitor 212. This makes it possible to sufficiently decrease voltage applied to the battery 217.

When power induced in an energy harvester is directly applied to a battery of which a charge voltage is about 2.5 V, a voltage higher than an upper limit (for example, 2.7 V) is not allowed to be applied. Thus, a method including not applying a voltage higher than or equal to 2.5 V to a battery using a Zener diode of which a Zener voltage is about 2.5 V, is conceivable. However, a protection current starts flowing with, for example, 1 V when the Zener diode of which a Zener voltage is about 2.5 V is used. This results in difficulty in efficiently charging the battery.

On the other hand, in the energy harvester 800 illustrated in FIG. 33, a protection current starts leaking at a sufficiently high voltage due to the use of the Zener diode 213 of which a Zener voltage is 6.5 V. This makes it possible to efficiently charge the battery 217 without occurrence of a protection current, even when the voltage of the battery 217 in a state of being fully charged is 2.7 V.

Further, the second capacitor 216 of which a withstand voltage is higher than the Zener voltage is provided parallel to the battery 217. Consequently, the second capacitor 216 also serves as a buffer when the voltage of the first capacitor 212 reaches the Zener voltage higher than the voltage of the battery 217 in a state of being fully charged. This makes it possible to avoid directly applying an excessive voltage to the battery 217. This makes it possible to improve the durability of the battery 217.

Furthermore, on the output sides of the first capacitor 212 and the Zener diode 213, the ideal diode 214, the switch element 215, the first voltage detector 218, and the second voltage detector 219 limit the charge voltage applied to the battery 217 such that the charge voltage is in an appropriate voltage range. Such a configuration makes it possible to efficiently charge the battery 217 while maintaining the durability of the battery 217 even when a voltage of 40 V is induced in the antenna section 130.

FIG. 35 is a circuit diagram illustrating another example of a configuration of an energy harvester. In an energy harvester 900 illustrated in FIG. 35, a rectifier circuit 230 is connected to the antenna section 130. The rectifier circuit 230 has a configuration similar to, for example, the configuration of the rectifier circuit 14 described with reference to FIG. 8.

Further, a voltmeter 231 that measures an output voltage of the rectifier circuit 230 is provided to the energy harvester 900. Here, the voltmeter 231 is a voltage sensor using, for example, a resistive element of a high resistance (greater than or equal to 2 MΩ, and favorably 10 MΩ).

Further, the rectifier circuit 230 is connected to a battery 232 through the backflow prevention diode 43, and the battery 232 is charged with output from the rectifier circuit 230. The output from the battery 232 is used as a power supply of the voltmeter 231.

The use of a high-resistance resistive element makes it possible to measure voltage induced in metal. Further, analysis of measurement data of voltage makes it possible to acquire an operation state of, for example, a motor or inverter that is included in an apparatus from which the energy harvester 900 harvests power. This makes it possible to understand a state of the apparatus, and thus to, for example, put out an alert before breakdown of the apparatus.

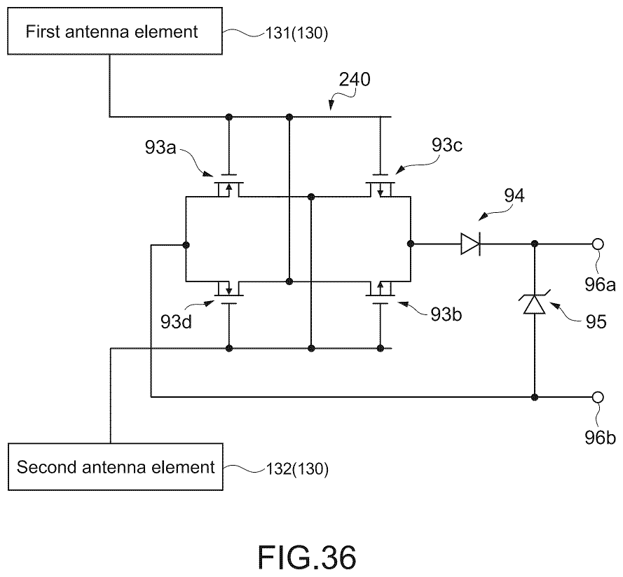

FIG. 36 is a circuit diagram illustrating another example of a configuration of a rectifier circuit. The rectifier circuit including a diode has been primarily described above. Without being limited thereto, a rectifier circuit that includes a field effect transistor (FET) may be used.

As illustrated in FIG. 36, a rectifier circuit 240 includes a rectifier circuit that includes four FETs 93a, 93b, 93c, and 93d, a backflow prevention diode 94, and an FET protecting Zener diode 95.

The FET 93a and the FET 93d are n-type FETs, and the FET 93b and the FET 93c are p-type FETs. When a positive voltage is applied to each of gates of the FET 93a and the FET 93d, current flows from a drain to a source of each of the FET 93a and the FET 93d. When a negative voltage is applied to each of gates of the FET 93b and the FET 93c, current flows from a drain to a source of each of the FET 93b and the FET 93c.

The drain of the FET 93a and the drain of the FET 93c are connected to each other, and the drain of the FET 93b and the drain of the FET 93d are connected to each other. The gates of the FETs 93a and 93c, and a connection point of the drain of the FET 93b and the drain of the FET 93d are each connected to the first antenna element 131. The gates of the FETs 93b and 93d, and a connection point of the drain of the FET 93a and the drain of the FET 93c are each connected to the second antenna element 132.

The sources of the FETs 93b and 93c are each connected to one of output terminals that is an output terminal 96a through the backflow prevention diode 94. The sources of the FETs 93a and 93d are each connected to another of the output terminals that is an output terminal 96b. The FET protecting Zener diode 95 is connected between the output terminal 96a and the output terminal 96b. The four FETs 93a, 93b, 93c, and 93d may each include a discrete semiconductor or a dedicated IC.

Note that, in this modification, the FET 93a and the FET 93d may be n-channel MOSFETs, and the FET 93b and the FET 93c may be p-channel MOSFETs.

Effects that are similar to the effects provided by the embodiments described above and their modifications can also be obtained when the rectifier circuit 240 according to this modification is provided to the energy harvester described above.

In particular, when a frequency at which harvesting is performed is a low frequency such as 50 Hz, an FET exhibits a higher efficiency in conversion performed by an element than a diode. Thus, an FET and a diode may be selectively used according to a frequency of an apparatus from which harvesting is performed.

When the energy harvester of the present technology is used by being in contact with or connected to a sensor that is used in a smart factory or a smart city and for which a battery change or power supply is necessary, this makes it possible to supply energy to the sensor. This results in being able to use energy efficiently. Thus, this may relate to “Affordable and Clean Energy”, which is the Sustainable Development Goal 7 from among the Sustainable Development Goals established in the United Nations Summit in 2015.

At least two of the features of the present technology described above can also be combined. In other words, the various features described in the respective embodiments may be combined discretionarily regardless of the embodiments. Further, the various effects described above are not limitative but are merely illustrative, and other effects may be provided.

In the present disclosure, expressions such as “same”, “equal”, and “orthogonal” include, in concept, expressions such as “substantially the same”, “substantially equal”, and “substantially orthogonal”. For example, the expressions such as “same”, “equal”, and “orthogonal” also include states within specified ranges (such as a range of +/−10%), with expressions such as “exactly the same”, “exactly equal”, and “completely orthogonal” being used as references.

Note that the present technology may also take the following configurations.
(1) An energy harvester, including:
   a coil section that includes
      a core that is made of a magnetic material, and
      a wire rod that is wound around the core;
   a maintaining portion that maintains the coil section on a surface of a target that includes a metallic body or a human body, such that an axis of the coil section intersects the surface of the target; and
   a rectifier that rectifies output from the coil section.
(2) The energy harvester according to (1), in which
   the magnetic material of the core is soft ferrite.
(3) The energy harvester according to (1) or (2), in which
   the core includes
      an axial portion around which the wire rod is wound, and
      a pair of flange portions respectively provided at two ends of the axial portion, and
   the maintaining portion maintains the coil section such that one of the pair of flange portions faces the target.
(4) The energy harvester according to (1) or (2), in which
   the core includes
      an axial portion around which the wire rod is wound,
      a flange portion that is provided at one of two ends of the axial portion, and
      a sidewall that is connected to the flange portion and spaced from the axial portion to surround at least a portion of the axial portion, and the maintaining portion maintains the coil section such that another of the two ends of the
   axial portion faces the target.
(5) The energy harvester according to any one of (1) to (4), in which
   the maintaining portion is a housing that accommodates therein the coil section and is attached to the surface of the target.
(6) The energy harvester according to (6), in which
   the housing includes an attachment surface that faces the surface of the target, the housing maintaining the coil section such that the axis of the coil section and the attachment surface are orthogonal to each other.
(7) The energy harvester according to (7), in which
   the core includes
      a first end surface that faces the target, and
      a second end surface that is situated opposite to the first end surface, and
   the housing maintains the coil section such that the first end surface of the core and the attachment surface coincide in a direction in which the axis of the coil section extends.
(8) The energy harvester according to any one of (1) to (7), further including:
   a nonmagnetic body that is arranged at a specified distance from the coil section; and
   a circuit section that is arranged across the nonmagnetic body from the coil section, the circuit section including the rectifier.
(9) The energy harvester according to (8), in which
   the nonmagnetic body is a plate member that has a thickness of greater than or equal to 0.3 mm.
(10) The energy harvester according to (8) or (9), in which
   the circuit section includes a circuit board in the form of a flat plate, the circuit board being arranged along the nonmagnetic body, and
   the nonmagnetic body is formed to cover a surface of the circuit board that faces the coil section.
(11) The energy harvester according to any one of (8) to (10), in which
   the nonmagnetic body is arranged parallel to the axis of the coil section, or is arranged to be orthogonal to the axis of the coil section.
(12) The energy harvester according to any one of (1) to (11), further including
   a dipole-structure antenna section that includes
      a first antenna conductor that is electrically coupled to the target, and
      a second antenna conductor that is a conductor different from the first antenna conductor, the second antenna conductor not being connected to the target, in which
   the rectifier rectifies output from the antenna section.
(13) The energy harvester according to (12), in which
   the rectifier includes
      a coil rectifier circuit that rectifies the output from the coil section, and
      an antenna rectifier circuit that rectifies the output from the antenna section.
(14) The energy harvester according to (12), in which
   the rectifier includes a shared rectifier circuit that rectifies the output from the coil section and the output from the antenna section.
(15) The energy harvester according to any one of (12) to (14), in which
   on the surface of the target, the first antenna conductor is arranged further outward than a region, on the surface of the target, that the coil section faces, and
   the second antenna conductor is arranged parallel to the axis of the coil section.
(16) The energy harvester according to any one of (12) to (14), in which
   the core includes
      a first end surface that faces the target, and
      a second end surface that is situated opposite to the first end surface,
   the first antenna conductor is arranged to face the first end surface, and
   the second antenna conductor is arranged to face the second end surface.
(17) The energy harvester according to any one of (1) to (16), further including
   a power storing section that charges, to a power storing element, power output from the rectifier.
(18) A charging apparatus, including:
   a coil section that includes
      a core that is made of a magnetic material, and
      a wire rod that is wound around the core;
   a maintaining portion that maintains the coil section on a surface of a target that includes a metallic body or a human body, such that an axis of the coil section intersects the surface of the target;
   a rectifier that rectifies output from the coil section; and
   a power storing section that charges, to a power storing element, power output from the rectifier.

### REFERENCE SIGNS LIST

1 target
4 earth ground
10, 50, 60, 80, 110 coil section
11, 61, 81 housing
12, 35, 62, 82, 112 nonmagnetic body
13, 36, 63, 83, 113, 140, 210 circuit section
14, 64a, 64b, 114, 141, 211, 230, 240rectifier circuit
15, 65a, 65b, 115 power storing section
16, 66a, 66b, 116 power storing element
20,51 core
21 wire rod
23, 53 axial portion
24, 54 flange portion
30, 90, 120, 130 antenna section
31, 91, 121 first antenna conductor
32, 92, 122 second antenna conductor
100, 200a, 200b, 300, 400, 500, 600, 601, 602, 700, 800, 900 energy harvester

What is claimed is:

1. An energy harvester, comprising:
a coil section that includes
a core that is made of a magnetic material, and
a wire rod that is wound around the core;
a maintaining portion that maintains the coil section on a surface of a target that includes a metallic body or a human body, such that an axis of the coil section intersects the surface of the target; and
a rectifier that rectifies output from the coil section.

2. The energy harvester according to claim 1, wherein the magnetic material of the core is soft ferrite.

3. The energy harvester according to claim 1, wherein
the core includes
an axial portion around which the wire rod is wound, and
a pair of flange portions respectively provided at two ends of the axial portion, and
the maintaining portion maintains the coil section such that one of the pair of flange portions faces the target.

4. The energy harvester according to claim 1, wherein
the core includes
an axial portion around which the wire rod is wound,
a flange portion that is provided at one of two ends of the axial portion, and
a sidewall that is connected to the flange portion and spaced from the axial portion to surround at least a portion of the axial portion, and
the maintaining portion maintains the coil section such that another of the two ends of the axial portion faces the target.

5. The energy harvester according to claim 1, wherein
the maintaining portion is a housing that accommodates therein the coil section and is attached to the surface of the target.

6. The energy harvester according to claim 5, wherein
the housing includes an attachment surface that faces the surface of the target, the housing maintaining the coil section such that the axis of the coil section and the attachment surface are orthogonal to each other.

7. The energy harvester according to claim 6, wherein
the core includes
a first end surface that faces the target, and
a second end surface that is situated opposite to the first end surface, and
the housing maintains the coil section such that the first end surface of the core and the attachment surface coincide in a direction in which the axis of the coil section extends.

8. The energy harvester according to claim 1, further comprising:
a nonmagnetic body that is arranged at a specified distance from the coil section; and
a circuit section that is arranged across the nonmagnetic body from the coil section, the circuit section including the rectifier.

9. The energy harvester according to claim 8, wherein
the nonmagnetic body is a plate member that has a thickness of greater than or equal to 0.3 mm.

10. The energy harvester according to claim 8, wherein
the circuit section includes a circuit board in the form of a flat plate, the circuit board being arranged along the nonmagnetic body, and
the nonmagnetic body is formed to cover a surface of the circuit board that faces the coil section.

11. The energy harvester according to claim 8, wherein
the nonmagnetic body is arranged parallel to the axis of the coil section, or is arranged to be orthogonal to the axis of the coil section.

12. The energy harvester according to claim 1, further comprising
a dipole-structure antenna section that includes
a first antenna conductor that is electrically coupled to the target, and
a second antenna conductor that is a conductor different from the first antenna conductor, the second antenna conductor not being connected to the target, wherein
the rectifier rectifies output from the antenna section.

13. The energy harvester according to claim 12, wherein
the rectifier includes
a coil rectifier circuit that rectifies the output from the coil section, and
an antenna rectifier circuit that rectifies the output from the antenna section.

14. The energy harvester according to claim 12, wherein
the rectifier includes a shared rectifier circuit that rectifies the output from the coil section and the output from the antenna section.

15. The energy harvester according to claim 12, wherein
on the surface of the target, the first antenna conductor is arranged further outward than a region, on the surface of the target, that the coil section faces, and
the second antenna conductor is arranged parallel to the axis of the coil section.

16. The energy harvester according to claim 12, wherein
the core includes
a first end surface that faces the target, and
a second end surface that is situated opposite to the first end surface,
the first antenna conductor is arranged to face the first end surface, and
the second antenna conductor is arranged to face the second end surface.

17. The energy harvester according to claim 1, further comprising
a power storing section that charges, to a power storing element, power output from the rectifier.

18. A charging apparatus, comprising:
a coil section that includes
a core that is made of a magnetic material, and
a wire rod that is wound around the core;
a maintaining portion that maintains the coil section on a surface of a target that includes a metallic body or a human body, such that an axis of the coil section intersects the surface of the target;
a rectifier that rectifies output from the coil section; and
a power storing section that charges, to a power storing element, power output from the rectifier.
